(19) United States
(12) Patent Application Publication
(10) Pub. No.: US 2025/0284535 A1
(43) Pub. Date: Sep. 11, 2025

(54) DEPENDABLE SOFTWARE AUDIO PROCESSING SYSTEM

(71) Applicant: Fourier Audio Ltd., London (GB)

(72) Inventor: Peter BRIDGMAN, London (GB)

(73) Assignee: Fourier Audio Ltd., London (GB)

(21) Appl. No.: 18/859,555

(22) PCT Filed: Apr. 25, 2023
(86) PCT No.: PCT/GB2023/051087

§ 371 Date: Oct. 24, 2024

Related U.S. Application Data
(60) Provisional application No. 63/334,311, filed on Apr. 25, 2022.

(51) Int. Cl. G06F 9/48; G06F 11/07; G06F 11/20

(52) U.S. Cl. CPC G06F 9/4881; G06F 11/076; G06F 11/2028

(57) ABSTRACT

A method is described for generating a dependable real-time audio processing system. An acyclic audio processing graph is partitioned 404-405 to generate one or more isolated partial subgraphs. The performance is measured 412 of one or more audio processors in the isolated partial subgraphs. The measured performance is analyzed 412 of the one or more audio processors to generate audio processor analysis data 413. Inter-subgraph scheduling 421 may be performed using the isolated partial subgraphs and the audio processor analysis data 413 to generate a per-CPU schedule 431. Intra-subgraph scheduling 422 may be performed using the isolated partial subgraphs and the audio processor analysis data 413 to generate a per-subgraph schedule (432).

### TECHNICAL FIELD OF THE DISCLOSURE

The disclosure generally relates to audio processing systems, and more specifically to a system and method for composing a dependable audio processing system from unreliable software audio processor modules.

### BACKGROUND

Audio processing systems generate output audio data created via a transformation of input audio data and/or human- or computer-generated input stimuli. The transformation may be user-defined or may come from a library of pre-prepared transformations. The output audio data may be a modification of the input audio data, or may be entirely synthesised by the audio processing system. An audio signal's data typically consists of a digitally quantised sequence of numeric values (‘samples’) which represent discrete sampled points on a single continuous waveform. One or more signals may be combined into a ‘channel.’ For example, the channel associated with a CD player has two signals, left and right, one for each component of the stereo audio data provided by the CD.

An audio processor is a software component which may accept audio input channels and produce audio output channels. It may also accept other stimulus data to modulate the action of the processor and/or produce stimulus data to provide information about a state of the audio processor or the audio data within it.

### SUMMARY

Aspects of the present invention are set out by the claims. Further aspects are also disclosed.

According to a first aspect, there is provided a method for generating a dependable real-time audio processing system. The method comprises: partitioning (404-405) the acyclic audio processing graph to generate one or more isolated partial subgraphs; measuring performance (412) of one or more audio processors in the isolated partial subgraphs; and analyzing the measured performance (412) of the one or more audio processors to generate audio processor analysis data (413). The method further comprises performing at least one of: inter-subgraph scheduling (421) using the isolated partial subgraphs and the audio processor analysis data (413) to generate a per-CPU schedule (431); and intra-subgraph scheduling (422) using the isolated partial subgraphs and the audio processor analysis data (413) to generate a per-subgraph schedule (432).

Partitioning into isolated partial subgraphs means that a level of “sandboxing” that is useful to the user in the end context-of-use can be achieved: particularly the distinction between FIG. 2 and FIG. 3 illustrates the advantage of our decomposition over what others do: we achieve increased isolation for outputs that the user logically considers separate, at the cost of slightly increased processing. Such isolation provides a significant advantage in dependability for the system, as failures in one processor are contained to a smaller number of output terminal sets than would otherwise be the case.

Without measurement, we have no accurate or meaningful way of determining the quality of a given schedule; the key question in pursuit of which is: does this schedule result in the processing happening in time? This question can be answered if the length of time of the processing is known. Similarly, other performance parameters allow the quality of a given schedule to be analyzed.

General purpose operating systems often contain runtime schedulers, which can be imperfect: they make on-the-fly scheduling decisions at runtime based on the set of tasks and set of available execution resources with which they are presented at any one instant in time. It is not possible for such a system to make optimal scheduling decisions because it does not have total knowledge of the full set of work that will need to be done: it allows for new work to be scheduled dynamically at runtime. Furthermore, general-purpose schedulers suffer from a further limitation in this context; they usually attempt to be ‘fair’, that is to say, any given task can fail to yield control at any point and yet the scheduler will “interrupt” the greedy task to ensure that other tasks have the ability to make progress.

This process generates latency in the system, as the context-switch overhead of interrupting and changing between tasks is significant, and the interruption will almost certainly not coincide with when the “greedy” task has actually finished doing its work. Such overhead manifests in reduced processing throughput, and, as general-purpose schedulers are not usually deterministic, additionally in increased jitter in system response times, a key design concern. This could be ameliorated by utilising a deterministic scheduler and setting the “quantum”, i.e. the time period for which a task is allowed to run, appropriately according to the generated schedule for each task, but to our knowledge this functionality is not available in generally-available schedulers.

An advantage of the disclosed system is that each correctly-performing task will terminate in a timely fashion. This avoids the need to pre-empt tasks at all, handing control from one to the next upon completion. There is no additional context-switching overhead above the tasks being performed as separate tasks.

It would be possible to avoid doing inter-subgraph scheduling, and simply present a set of processes to the operating system to schedule at will. This would involve invoking the operating system's general-purpose scheduler, with the performance costs that brings.

It would be possible to avoid doing intra-subgraph scheduling, and simply presenting a set of threads within a given subgraph to the system to schedule at will. This results in the operating system's scheduler context switching between the available threads at will.

Optionally, the method further comprises inferring (401-403) delta nodes as needed to convert a received audio processing graph into the acyclic audio processing graph. Real world systems are typically causal; they often have their inputs in order to generate their outputs. Many digital signal processor (DSP) systems address this requirement by imposing a restriction that the demanded processing graph be acyclic. By introducing a one-period delay into the system, we once again make the system causal, whilst admitting cyclic graphs, at the penalty of latency in the cycle. This is beneficial to the user in that it increases the flexibility of the system, allowing them to configure more complex and interesting processing graphs. Note that the feature of inferring delta nodes is not essential, because it might not be necessary for the audio processing to be converted into the acyclic audio processing graph.

Optionally, the method further comprises configuring an audio processing system according to the per-CPU schedule (431) and the per-subgraph schedule (432). Thus the audio processing system can be configured to perform the inter-subgraph scheduling, the intra-subgraph scheduling, or both.

Optionally, the method further comprises adding (406-407) redundancy to one or more of the isolated partial subgraphs. Optionally, the per-CPU schedule (431) is generated by performing inter-subgraph scheduling (421) using the isolated partial subgraphs (407). Optionally, the per-subgraph schedule (432) is generated by performing intra-subgraph scheduling (422) using the isolated partial subgraphs (407). When a fault is encountered in a subgraph, the most expedient & reliable method to remove that fault is to replace the subgraph. The speed and seamlessness with which this can be done has a direct bearing on the dependability of the system as a whole: even if a given processor is not dependable, the system can use redundancy to make the system as a whole dependable.

Optionally, the audio processing graph is received (401) by it being specified by a user. The user may wish to directly specify the graph that they want executed, without having to specify the intricacies of how that should be decomposed, duplicated for redundancy, etc. in order to make it reliable. The system performing this analysis despite the user having provided a complex input description of processing allows for great expressiveness without the user needing to care about implementation details.

Optionally, the audio processing graph is received (401) by the user selecting a pre-specified audio processing graph. It is useful for the user to be able to draw on a bank of pre-configured graphs; they may not even know the details of what the graph is, only that it is an available mode of processing.

Optionally, the audio processing graph is received (401) from an available set of audio processor software modules. The user may interact with some other piece of software, which is responsible for generating the graph, which is then decomposed and executed by the system. This may allow them to express their desired processing in a more ergonomic manner than in the form of a graph.

Optionally, measuring the performance (412) and analysing the measured performance (413) are performed before the inferring (401-403) of the delta nodes and the partitioning (404-405) of the acyclic audio processing graph. The analysis procedure may take some time, and so being able to perform it ahead-of-time from when the processing is actually wanted, and to store & use the results may make for a more efficient user experience by allowing for quicker graph mutations.

Optionally, the method further comprises inserting one or more nodes into the acyclic audio processing graph, wherein the one or more nodes includes a sigma node, a phi node and/or a delta node. Optionally, the method further comprises performing parallel processing of the acyclic audio processing graph. Utilising delta-nodes to fracture a subgraph into two or more sub-subgraphs may make schedules that were previously un-schedulable possible. The previous schedule may have been impossible because there was a subgraph whose time requirement was simply longer than the available period, or it may have been impossible due to the geometry of the available resources simply not being able to accommodate the proposed processing, despite the total “area” of available resource being greater than the proposed processing (see example in description). As such, this scheme confers an advantage in that it allows the user to achieve more complex & demanding processing than would otherwise be possible on the same hardware under this scheme.

Optionally, the method further comprises performing (412-413) fault detection of the one or more audio processor by analysis of input data that is provided to the one or more audio processor and output data that is received from the one or more audio processor. Optionally, the method further comprises performing (412-413) fault detection of the one or more audio processor by analysing memory consumption of the one or more audio processor. Optionally, the method further comprises performing (412-413) fault detection of the one or more audio processor by setting one or more input stimulus parameters, detecting whether the one or more audio processor exhibits a fault, and recording the one or more input stimulus parameters if the fault is detected. Thus, various approaches are available for detecting faults, which allow action to be taken to remove those faults.

Optionally, the method further comprises employing dual audio networks to provide a configuration comprising a primary network and a failover network. Advantageously, the system leverages redundant properties of the network by having redundant pairs of hosts present themselves inversely to the two audio networks.

Optionally, the method further comprises employing: a first parallel and independent audio network (M); a second parallel and independent audio network (N); a logical host (X) configured to perform a set of processing tasks; a first parallel and independent implementation of the logical host (A); a second parallel and independent implementations of the logical host (B); and a client (C) configured to exchange data with the logical host (X) via the first and second audio networks (M, N), the client (C) being configured in a primary/secondary redundant arrangement. The first logical host (A) presents itself as the logical host (X) on the first audio network (M). The second logical host (B) presents itself as the logical host (X) on the second audio network (N). If the first logical host (A) were to fail, the client (C) would assume that the first audio network (M) has failed, and fall back to the second audio network (N), wherein correct service would be restored due to the function of the second logical host (B). Providing host redundancy confers a significant advantage in implementation, in that that there are many extant clients that already support network redundancy. This method leverages that fact to provide a wider scope of redundancy (to additionally cover host failure) than that scheme was originally conceived to provide. In contrast, existing state of the art in audio over IP networks requires all hosts to present identically on both the primary and the secondary networks.

According to a second aspect, there is provided a method for generating a dependable real-time audio processing system, the method comprising: partitioning (404-405) an acyclic audio processing graph to generate one or more isolated partial subgraphs; measuring performance (412) of one or more audio processors in the isolated partial subgraphs; and analyzing the measured performance (412) of the one or more audio processors to generate audio processor analysis data (413). Note that it is not essential to perform both, or in fact either, of performing of inter-subgraph scheduling (421) and intra-subgraph scheduling (422). Instead, an alternative option would be to avoid performing either or both ahead-of-time scheduling steps described and instead defer scheduling until runtime by delegating to the scheduler of an operating system (OS) which is being executed by the audio processing system.

According to a third aspect, there is provided a program which, when executed by a computer, causes the computer to perform a method according to the first aspect or the second aspect.

According to a fourth aspect, there is provided a computer-readable storage medium storing a program according to the third aspect.

According to a fifth aspect, there is provided an audio processing system configured to implement the method recited by the first aspect. The audio processing system may comprise a single-core processor or a multi-core processor. The audio processing system may be software-based, or alternatively may be implemented as field-programmable gate arrays (FPGA).

### BRIEF DESCRIPTION OF THE DRAWINGS

For a more complete understanding of this disclosure, reference is now made to the following brief description, taken in conjunction with the accompanying drawings in which like reference numerals indicate like features.

FIG. 1 is a block diagram of an audio processing system according to the disclosure;

FIG. 2 illustrates two partial subgraphs;

FIG. 3 illustrates isolated partial subgraphs;

FIG. 4 illustrates the steps executed by a method according to the disclosure to transform a user's specified processing graph into audio processing schedules that can be executed by a CPU;

FIG. 5 illustrates an initial candidate schedule (left-hand image) and an admissible candidate schedule (right-hand image), with the cores of a CPU represented as columns, with assigned subgraphs;

FIG. 6 illustrates an assignment of buffers to audio processors in a subgraph indicating a result of the first buffer allocation process;

FIG. 7 illustrates an assignment of buffers to audio processors in a subgraph showing simple reverse-breadth first search allocation with buffer forwarding;

FIG. 8 illustrates various redundancy schemes according to the disclosure; and

FIG. 9 is a block diagram of a network device according to the disclosure.

### DETAILED DESCRIPTION

Preferred embodiments are illustrated in the figures, like numerals being used to refer to like and corresponding parts of the various drawings.

### 1 Introduction

An audio processing system according to the disclosure allows a user to compose and execute a number of potentially unreliable software audio processors in a configuration and manner that the user will consider to be dependable.

### 2 System Context

An audio processing system according to the disclosure (also referred to herein as “the system” or “a system” or “the described system”) runs on a software-controlled processor with one or more concurrent execution units. Non-limiting examples of such a processor include a microprocessor as commonly used as the CPU in PC-based systems, a GPU, or a microcontroller in an embedded system. All are referred to herein by the term CPU, with concurrent execution units termed cores.

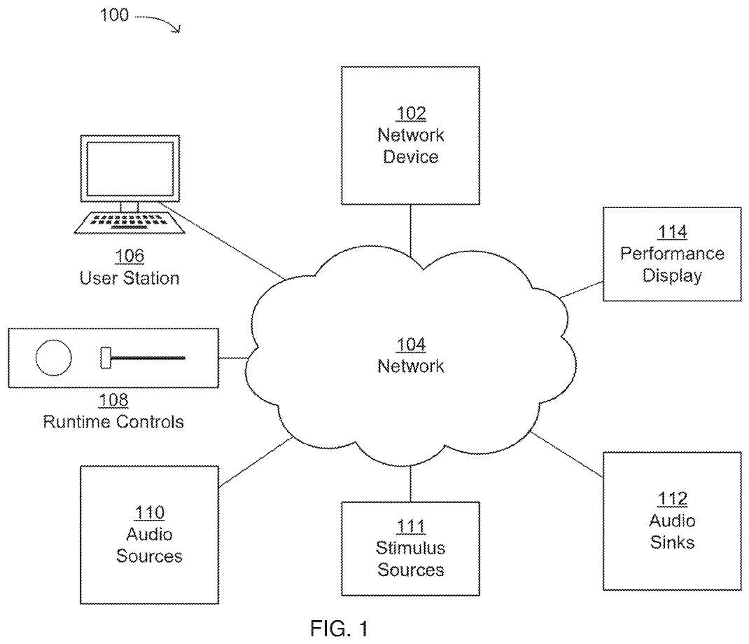

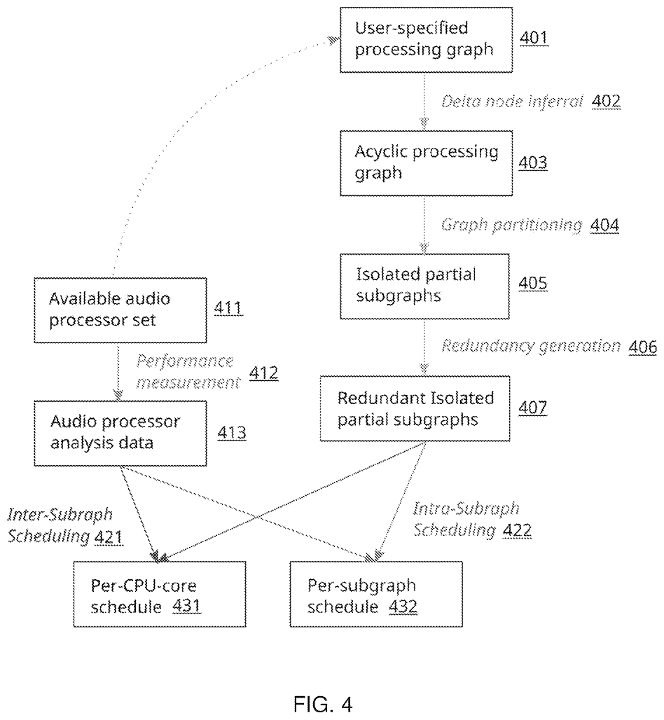

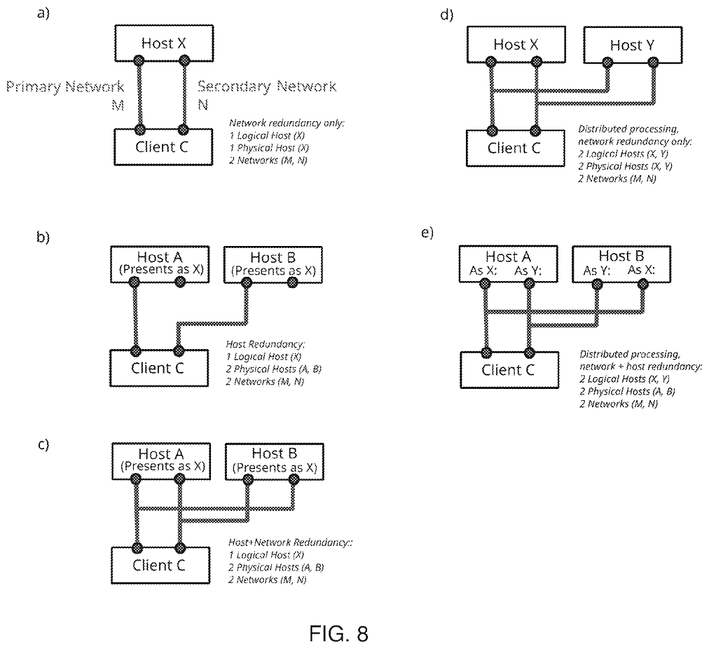

FIG. 1 is a block diagram of an audio processing system 100 according to the disclosure. A network device 102 performs the methods and processes of the audio processing system 100, as described in more detail with reference to FIGS. 4 and 8. The network device 102 is communicatively coupled to a network 104, which may be an internet protocol (IP) network or other suitable communication network. Also communicatively coupled to the network 104 are a user station 106, one or more runtime controls 108, one or more audio sources 110, one or more stimulus sources 111, one or more audio sinks 112, and a performance display 114. Some embodiments of the audio processing system 100 may be configured without one or more of the user station 106, runtime controls 108, audio sources 110, stimulus sources 111, audio sinks 112, and performance display 114, depending upon the application of the system 108. The audio sources 110 comprise microphones, musical instruments, audio streaming networks, sound mixers, compact disc (CD) players or any other suitable source of audio signals (or samples). The stimulus sources 111 comprise data sources such as software user interfaces, physical human-machine interfaces, a time code, a Musical Instrument Digital Interface (MIDI) keyboard, or a MIDI recorder. The audio sinks 112 comprise speaker systems, sound mixers, audio streaming networks, audio recording devices, or any other suitable receiver of audio signals.

The network device is configured to receive one or more audio processing graphs and other input information from a user of the user station 106, a disk, or an external system and process the received audio processing graph(s) to generate one or more independent subgraph(s) and schedule(s) describing a dependable real-time audio processing system, using the methods and processes disclosed below.

The network device 102 is also configured to operate to receive audio signals from one or more of the audio sources 110, process the received signals using the real-time audio processing system described by the one or more independent subgraph(s) and schedule(s), and send the processed signals to one or more of the audio sinks 112. The one or more independent subgraph(s) and schedule(s) may be stored in the network device 102 subsequent to its own processing or may be obtained from an external source via the network 104 or stored on a disc or other non-volatile memory device in the network device 102. Signals from the runtime controls 108 may be received by the network device and modify the processing of the received signals according to the audio processing graph. The network device 102 may display performance parameters of one or more elements of the real-time audio processing system to a user via the performance display 114.

In audio processing system according to the disclosure, the overall goal is to generate output audio data created via a user specified transformation of input audio data and/or human- or computer-generated input stimuli. The output audio data may be a modification of the input audio data, or may be entirely synthesised by the system. The basic subdivision of audio data is a single signal, which represents one continuous waveform.

Each signal's data typically consists of a digitally quantised sequence of numeric values (‘samples’) which represent discrete sampled points on a single continuous waveform. A sample is interpreted in the context of the rate at which the original, analogue waveform was sampled, known as the ‘sample rate’. In that context, a single sample can be understood to have a ‘duration’ of the reciprocal of the sample rate; that is, if a given signal was sampled at a sample rate of fₛ=50 kilohertz (kHz), each sample's ‘duration’ is 20 microseconds (μs). The ‘sample rate’ is usually constant throughout an entire audio processing system, but this is not necessarily true in the general case.

In some embodiments, one or more signals are combined into a ‘channel’, which represents a bundle of signals associated with a single origin, purpose, or destination. For example, the channel associated with a CD player has two signals, left and right, one for each component of the stereo audio data provided by the CD. A channel could theoretically have many more signals where the source being described has a higher intrinsic ‘dimensionality’.

The samples in a signal are usually grouped across the time domain into contiguous blocks called ‘buffers’, with all buffers in the system containing the same number of samples (the ‘buffer size’). Some embodiments may include buffers of more than one size. A buffer's ‘duration’ is simply the buffer size multiplied by a sample's duration, so a 64-sample buffer at 50 kHz will have a duration of 1.28 milliseconds (ms).

Software audio processing systems usually use buffers as their unit of work rather than processing samples individually: not only do many digital signal processing algorithms require multiple samples to calculate an output, but doing so may improve performance and decrease the system's sensitivity to jitter.

Jitter in a time-series processing system describes a variance in delivery time of a result with respect to the time it was expected to arrive. Real-world digital systems may experience some jitter due to nondeterminism in their clocks, and the influence of unpredictable external asynchronous actions on the system.

If a system is expected to deliver a result at a periodic interval P, and the time taken to calculate that result is nominally t, then the system can tolerate a maximal jitter in t of jₘₐₓ=P−t and remain timely. Even if the proportion of P consumed by t remains constant as P is increased, a greater P permits for a greater absolute jₘₐₓ, which relaxes the engineering specification of the system.

For example, if the system was to calculate each output sample one-by-one, at a typical fₛ of 48 kHz, P=20.8 μs. If the system calculates output data 16 samples at a time, P=332.9 μs. If it is assumed the t to process a sample is 10 μs and scales linearly with number of samples processed, then the acceptable jₘₐₓ in the first system is 10.8 μs, but in the second system is 172.9 μs, a significant difference.

In addition, on many modern digital processing architectures the assumption that processing 16 samples in one block takes the same amount of time as processing 16 samples individually does not hold; the ‘constant-factor’ work involved in processing a series of samples of any length (for example, issuing an instruction to copy samples from input to output) means that greater buffer size amortises this cost across more samples, for a lower overhead-per-sample. This essentially decreases the t per sample, meaning that the system could either do more complex work (increasing t) or tolerate a higher jₘₐₓ.

### 2.1 Audio Processors

An audio processor is a software component which accepts zero or more audio input channels and produces zero or more audio output channels. It may also accept other stimulus data (which tend to modulate the action of the processor) and/or produce stimulus data (which can provide information about the state of the processor or the audio data within it). These stimulus data, whether input or output, are generically referred to as ‘parameters’.

Three broad ‘classes’ of audio processor are identified herein; ‘effects’, ‘instruments’, and ‘analysers’. An audio processor which has one or more input audio channels and one or more output channels is generically termed an ‘effect’ (it modulates the input audio in some way). A processor which has zero input channels and one or more output channels is generically termed an ‘instrument’ (it produces audio). A processor which has one or more input channels and zero output channels is generically termed an ‘analyser’ (it reports properties of the input audio via its parameters).

This disclosure treats all three classes of audio processor equally, as they behave similarly in the system; all processors are treated as discrete, composable, modular software components which conform to the described interface.

### 2.2 the Audio Processing Graph

A graph can be described as a data structure consisting of zero or more nodes and zero or

more edges, where an edge is a connection between any two nodes. A directed graph modifies these edges to have a direction; travelling from a source node to a sink node. A cycle in a directed graph is an arrangement of nodes and directed edges where, by starting at a given node and following directed edges from source to sink, a traveller can arrive back at the starting node. A directed acyclic graph is a directed graph in which the composition of nodes and edges does not admit any cycles.

In an audio processing system, a user or designer of the system may design the audio processing to be applied to the input signals by combining a number of different audio processors, with outputs from one set of processors being routed into the inputs of others. Such a system may be modelled as a directed graph: each audio processor input signal or system external output signal is a ‘sink’ node, each audio processor output signal or system input signal is a ‘source’ node, and each connection from a ‘source’ node to a ‘sink’ node is a directed edge.

Within each processor, there is an implicit edge from each input node to each output node, in that the processor requires any of its inputs that are connected to a source to have data in order to calculate any of its outputs.

Most graphs as configured by users are likely to be acyclic graphs, but this restriction does not necessarily hold in the general case, as users may wish to create feedback loops for specific audio effects, especially when an audio processor does not actually pass audio data from the ‘feedback’ input channel directly to its output channel, but instead uses the data to modulate its operation.

However, as a digital audio processing system requires clocked stable inputs in order to determine outputs, a ‘feedback’ loop uses ‘buffered’ audio from a previous evaluation of the graph. An edge creating a cycle and therefore utilising such a ‘buffer’ is no longer a direct link from a calculated output into an input, and therefore should actually be modelled as two separate nodes in the graph (referred to herein as a pair of buffer nodes), a source node and a sink node, thus breaking the cyclic chain of edges in the modelled graph. This step may be referred to as “delta node inferral.”

In the described system, if a user-defined or pre-configured system includes a cycle in a desired processing graph, the system automatically inserts a feedback buffer node in order to transform the requested directed cyclic graph into a directed acyclic graph, suitable for processing. Other embodiments may require or allow the user to explicitly demarcate the location of a required buffer node in order to achieve an acyclic graph, or may prohibit the user from requesting a cyclic graph entirely.

The “depth” of a node in an acyclic graph can be considered to be the maximal number of edges that can be traversed by following inbound directed edges from the node in the backwards direction until there are no more edges that can be traversed; it is a measure of how “far into” the graph a given node is.

The “delay” ta of a node can be defined as follows; given an impulse input signal present at the input of an audio processor in a sample representing time to, to +ta is the first instant at which non-zero energy is observed at the output. The “delay depth” of a node can be considered to be the combination of the two concepts; for a given node, its delay depth can be described as a pair of numbers, (Σt_{d min}, Σt_{d max}), where Σt_{d min} of a node is the lowest Σt_{d min} from all inbound nodes plus the node's t_{d}, and Σt_{d max} of the node is the highest Σt_{d max} from all inbound nodes plus the node's ta.

Thus, for a given graph, different output sink nodes may have different Σt_{d min} and/or Σt_{d max} values, and any node in the system may have Σt_{d max}≠Σt_{d min}. This may be undesirable to a user, who may prefer all audio processor inputs, and all outputs of the system, to have identical Σt_{d min} and Σt_{d max} values and for Σt_{d max}=Σt_{d min} for all nodes, so as to provide phase coherence in its output signals. To achieve this, embodiments of the system may insert delay nodes into the graph after delta node inferral (as described in Section 5.1), setting the delay time of these nodes as appropriate so as to cause each input to a given node to appear as having the same Σta and to cause all output sink nodes of the system to also have the same Σt_{d}.

In graphs with output nodes having very different depth or delay depth however, such a process may produce an undesirable effect where, due to the user's request that all output sink nodes be coherent, one outlier sink node with a very large Σt_{d max} causes all output sink nodes to be delayed significantly. To resolve this, embodiments of this system may allow the user to exclude certain output nodes from the calculation of delay values. Some embodiments of the system may automatically detect large outlier Σt_{d max} values resulting in significant output buffer delays being generated, and notify the user of this situation, or may automatically exclude such nodes from the Σt_{d max} output calculation.

### Pipelining Via Delta Nodes

In graphs with output nodes having depth >2, it is conceivable that the system may not possess sufficient processing power to complete all required processing to produce a set of output sample values for a given output node within the available buffer time, given that each node's output value must be computed serially (with higher-depth processors requiring the outputs from lower-depth processors to compute their own output).

The system may be able to detect this situation automatically (e.g. when no solution to the inter-subgraph scheduling problem discussed below in section 5.3 can be found within a reasonable time).

To resolve this, the system may automatically insert, or may allow the user to insert, delta nodes into the graph, so as to only require the processing found between the input source node and the delta-sink node, and the delta-source node and the output sink node, to be able to be achieved within any one buffer period. These two elements of processing may then occur in parallel, as the previously higher-depth nodes are now using the data from the delta-source node—i.e. data calculated during the previous period-instead of data from the input source nodes, to calculate their output.

### 2.3 Definition of Dependability

This disclosure adopts as a definition of the dependability of an audio processing system the ability of the system to provide correct service. In order to reason about the dependability of a system, it is necessary to consider what a user may perceive as ‘correct service’ in the system's reasonably intended context of use.

‘Incorrect service’ may be considered to be when a fault in the system can be observed causing the system to fail to meet its specification at a boundary of that system. Disclosed herein are both the specification required for correct service and the boundary at which that specification will be observed.

Because all real-world systems exhibit faults, a system according to the disclosure is concerned with minimising the observable extent of incorrect service in normal operation. That is to say, the described system, when implemented correctly, may not meet our definition of ‘correct service’ at all times, but uses a variety of techniques to minimise the deviation therefrom.

### Service Boundary

The service boundary for the entire system is considered to be the audio outputs from the system, provided as a set of signals, each consisting of a stream of numerical audio sample data. Within the system, the correctness of service provided by a given processor may be considered by taking the service boundary to be the output signals of that processor.

### Service Specification

When operating correctly, the system provides output data, in the form of audio samples, for one or more output signals provided by the system, in both a timely and correct fashion.

“Timely” means that for example, if the system has been configured to have buffers with ‘duration’ D=bR⁻¹ where b is the buffer size and R is the sample rate in Hz, and an input is clocked into to the system at time to, then the output should be calculated and output before L (to +D) where L is a fixed latency offset for the system, measured in buffers.

“Correct” means that for example, the output signals provided by the system are an accurate representation of the application of the audio processors in the configuration provided by the user to the set of input audio signals provided to the system at that time, without additional distortion, omission, or modification of the signal.

### 2.4 Degrees of Failure

While a failure of dependability is a deviation from the specification of correct service, there are varying degrees of failure possible as the system's behaviour diverges further from the specification.

### Failures of Timeliness

If the system is unable to provide the calculated samples for an output signal before the specified deadline, then it is considered a failure of timeliness.

The best possible failure of timeliness is one where the system increases the buffer duration (or the accepted latency multiplier L) from the configured duration, and then subsequently consistently meets the new, relaxed timeliness deadline. The increase in buffer duration will produce a single discontinuity in output samples according to the difference in buffer durations (which will be audible), but prevents audible discontinuities thereafter at the price of increased system latency.

An alternative, worse failure of timeliness is where the system repeatedly fails to calculate the output signal data before the deadline. This will produce repeated, audible discontinuities in the output signal, and is therefore desirable to avoid.

### Failures of Correctness

If the system produces output data signals that do not faithfully represent the requested processing of the provided input data signals, then it is considered a failure of correctness. A failure of correctness can arise from a fault in the audio processor itself, or a fault in the system that is managing and running the audio processors.

The worst possible failure of correctness is where the output data signals are non-zero and are entirely uncorrelated with the input data signals. This will usually manifest as a signal that sounds like an unpleasant noise, and can be very dangerous if the system's outputs are connected to powerful real-world transducers.

A less offensive, but still problematic failure of correctness is where the output data signals are silent, despite non-silent input signals being provided to the system. This is nonetheless preferable to outputting uncorrelated noise.

A variant on this failure of correctness is a mode where the input signals contributing to a given output signal are presented unprocessed as output signal. This allows the system's outputs to continue to be potentially useful, despite perhaps having very different characteristics than might be expected.

An improved failure of correctness therefore is where the input signals are processed not in the manner specified, but via some alternative processing which preserves some of the characteristics of the originally-specified processing. The closer the alternative processing matches the specified processing, the less observable the failure of correctness will be.

### 3 Fault Detection & Removal

To achieve dependability, the system observes a number of markers that might indicate that a fault is present, and then takes action to remove those faults. In this section, various approaches are disclosed for achieving this.

The system scores the various markers available to it differently, such that a high-certainty marker may result in immediate action, while a number of low-certainty markers may in concert serve to confirm each other's indications.

Additionally, the system may weight the resource (memory, CPU time) requirements of implementing each detection mechanism, only triggering more expensive detection mechanisms for additional certainty once a ‘cheap’ detection mechanism has triggered.

Alternatively, the system could choose to only perform these analyses from time-to-time, rotating between different analyses to share the available spare processing time.

### 3.1 Detection: Audio Analyses (See 412-413 in FIG. 4)

By analysing the audio data being input and output from an audio processor, the system may obtain information about the correctness of the processor.

### Expected Energy Analysis

Audio processors of the ‘instrument’ or ‘effect’ types can usually be expected to produce energy (non-zero signal) in their output when they receive parameter stimulus or a significant quantity of input audio data, respectively. Failure to do so may be an indication of a failed audio processor.

The system monitors the input stimulus/energy of instrument/effect type processors respectively, and measures the output energy, over a time-windowed period. If input stimulus/energy is recorded but the output window starting at that input's time (potentially offset by a given processor latency) doesn't show energy, the system may register a failure signal at a low level of certainty. The system may choose to expand the analysis time window in this case, which would increase the level of certainty.

For example, a reverb may have a long pre-delay (e.g. 0.5 s), which a small window more appropriate for detecting failure in a low-latency audio processor such as an EQ would report as faulty. By dynamically increasing the window size the expectation of correct detection can be increased.

An expected correct window size and/or latency in which energy should be observed can be established heuristically by an ahead-of-time analysis step, when the audio processor is confirmed to be working correctly and its input-to-output-energy delay is measured.

### Frequency Analysis

Audio processors generally produce output signals representing real-world signals that are free from discontinuities; that is, their outputs represent audio signals that are realisable in the real world. In the real world, a discontinuity in a signal might represent a frequency component of infinite frequency, and so such a signal would not physically exist.

In the quantised domain, although quantised samples are by definition not continuous, apparent large discontinuities in the represented signal will be reflected in large amounts of very high-frequency energy in the output signal. The more ‘discontinuous’ two samples are, the more high-frequency energy the signal will appear to contain.

Most audio effect processors are very unlikely to present such high frequency energy at their outputs if such energy is not present at their inputs, unless they are functioning incorrectly¹. For example, a processor that is repeatedly outputting the same buffer without updating the buffer will produce a signal with a discontinuity at every buffer repetition. 1 This is especially true at high sample rates that can support faithful sampling and processing of ultrasonic information.

As such, the system may perform a frequency-domain energy analysis on the input and output signals of a processor, and if there are significantly more very-high-frequency components in the output than the input, then there is likely to be a fault present. In other embodiments, the system could analyse only the output of the processor and, in the event that there is a large amount of ultrasonic information present, determine with a low degree of certainty that there is a fault present. Such embodiments may then trigger the input analysis to determine whether this processor is inserting the noise (thus confirming there is a fault present).

Similar to the expected energy analysis, an expected high-frequency energy floor can be determined heuristically by an ahead-of-time analysis step when the audio processor is confirmed to be working correctly.

### Output Buffer Canary Data

Many realisations of the interface for invoking audio processors rely on a processor writing its output data into a provided buffer of memory. To save CPU time, the system may make no warranties as to the contents of that buffer before it is provided to the audio processor, as setting its contents would take time that will only be wasted when the audio processor overwrites the contents with its output data.

However, if a fault in an audio processor causes it to fail to write its output data to such a buffer, then the system may interpret the garbage data in the buffer as its actual output, producing a failure of correctness.

To detect this situation, the system may pre-populate a small amount of the audio processor's output buffer with ‘canary’ data, which is obviously not a valid output of an audio processor (such as the ‘NaN’ or ‘+Infinity’ floating point values). If these values are detected in the output buffer after the audio processor has run, then the system has detected that a failure of correctness may exist in the processor.

### 3.2 Detection: Metadata Analyses (See 412-413 of FIG. 4)

There are a number of markers aside from observable audio data which can be used to suggest the presence of faults in the system. This subject is discussed further in Section 5.5, “Runtime performance measurement.”

### Memory Consumption

Audio processors are often able to request the use of additional random-access memory (RAM) from an execution environment. However, RAM is a constrained resource, and exhausting the supply of available RAM can result in a system failure. As such, an audio processor, when functioning correctly, will only request and utilise a bounded quantity of RAM.

Whilst the system might not know the expected steady-state value of the amount of RAM consumed by an audio processor, it can observe the rate of change of the RAM consumption. This should reach zero sometime after the audio processor has finished its initialisation and should not change unless the user provokes a reconfiguration of the audio processor via a parameter change. If the rate of change (over a given window) is nonzero, it is likely that a fault, in the form of a memory leak, exists within the processor.

### Hardware Signals

When software running in a hardware environment executes an illegal operation or attempts to put the system into an illegal state, the hardware may respond by issuing a signal, interrupt, or trap to the execution environment to inform it of this fact. If an operating system is present, the operating system may intercept and handle this signal, either by routing it to the originating software, or by terminating the originating software process.

By detecting the issuance of these signals or their effects, the system can infer that an audio processor has exhibited a fault.

Depending on the hardware architecture, it may be that it is not easy to determine precisely which audio processor in a set initially produced the fault so, in some embodiments, the system may assume that all processors in the set are faulty after observing a single fault related to that set.

### Audio Processor Timeliness

Audio processors calculate output samples within a relatively constrained deadline. If they fail to do so, there is a failure of timeliness, which can translate into a failure of correctness if the output of the system runs at a fixed rate and therefore outputs the wrong data when the correct data have not yet been calculated.

By recording high-resolution timestamps at a time that a processor is triggered to run and at a time it completes its processing on a given buffer of input audio samples, the system may determine a duration of the processing operation and therefore whether the audio processor exhibited a failure of timeliness. This may indicate the presence of a fault in the audio processor, especially if missed-deadlines start occurring mid-operation in an audio processor that previously was meeting its deadlines.

### 3.3 Removal

As the audio processors appear to the system as black boxes, once the system detects a fault with a given processor, in some embodiments fault removal is effected by replacement of the faulty audio processor. Whilst this will not fix the implementation fault that has led to incorrect service being provided, it may remove a latent fault that was only observable as a result of operation of the processor.

This task may be made more complex by the fact that it may not be possible to isolate the detection of incorrect service to a single audio processor. To return the system to correct service as quickly as possible, the entire set of audio processors whose correctness is in question may be replaced, rather than attempting to replace audio processors incrementally.

Techniques for replacing faulty audio processors whilst minimising the duration and extent of incorrect service are discussed further in Section 6, “Fault tolerance & recovery.”

### 4 Fault Forecasting

To attain a dependable system, it may be useful to be able to predict the conditions under which an audio processor is likely to exhibit a fault. Two examples of analysis-led approaches for doing so are discussed below: Performance measurement and Audio processor reliability fuzzing. Such analyses may be pre-computed and stored or the analysis results loaded from an external source.

In both approaches, the results of the analysis may not change across different instances of the same hardware or processor invocations, and so the analysis can be stored and re-used. To do so, the system creates a ‘fingerprint’ that uniquely identifies an audio processor running on a given hardware configuration; this could be created for example by calculating a hash of the compiled audio processor machine code concatenated with a digest of the system hardware architecture.

The analysis results can then be stored independently of the processors themselves; this allows a manufacturer of the system to perform analysis for a wide range of commonly-used audio processors ahead of time and ship a library of analysis data with the system. When loading an audio processor, the system can then consult its library of analysis data to determine if it already has pre-computed data for a given processor, and only run an analysis at load-time if no pre-computed data is found. Such load-time-computed data can be cached in the system so that subsequent loads of the audio processor can re-use the previously-generated analysis data.

Audio processor manufacturers could also pre-compute analysis data for their processors and distribute this data alongside the processor in a combined package, for increased user confidence (by advertising the analysis results, e.g. in the user interface (UI)) and improved first-use loading times (as load-time analysis doesn't need to be performed).

In such a scheme, the precomputed analysis data could be cryptographically signed by the audio system manufacturer to authenticate it, preventing the processor manufacturer from being untruthful about the reliability of its processors. In this case the system could choose not to use analysis data which is not signed by the system manufacturer, and simply re-run analysis at load-time for that processor.

### 4.1 Performance Measurement

The system may predict the likelihood of an audio processor to exhibit a failure in part by measuring the audio processor's resource (e.g., processing time or RAM) requirements ahead-of-time, and then comparing those requirements with the conditions available at runtime, knowing that a resource exhaustion is one of the most likely modes of failure for the system.

In all such ahead-of-time calculations, the system inputs a variety of input signals to the processor to enable it to be exercised under a variety of conditions: signals consisting of silence, very small (denormal²) samples, and very loud (clipping) samples may all be tested, in addition to more conventional signals, at a range of frequencies. 2 When samples are represented with IEEE-754 floating point numbers as is common in audio processing systems, there are a class of numbers which are too small to be represented in the same manner as most other numbers in the representation scheme. These numbers are termed ‘denormal’, and calculations utilising them often have severely impaired performance compared to those using ‘normal’ numbers due to special slow-path handling required for the ‘denormal’ representation.

### Processing Time

An audio processor exhibits a failure of timeliness if it fails to produce output samples before the required deadline. Processing durations for audio processors may be modelled as a statistical process with a log-normal distribution.

By sampling observed processing durations of an audio processor in an ahead-of-time measurement process, the system can characterise this distribution to determine the percentage likelihood of a failure for any given deadline; the probability of failure is given by the integral of the calculated probability distribution function, bounded over the proposed deadline up to +00.

By specifying a tolerably low probability of failure, an appropriate deadline for any given audio processor can be selected within which a correctly-behaving audio processor can be expected to complete its processing. Expecting the processor to complete in a shorter deadline is then likely to result in a failure of timeliness.

### RAM Consumption

An audio processor is likely to require the use of an amount of system RAM. This can be measured by running a given processor in isolation and measuring the amount of system RAM requested or allocated by the processor.

### 4.1.1 Performance Differentiation Feedback

An audio processor may have different resource requirements when in one configuration than when in another, and it may be perfectly possible to run a large number of processors in one configuration, while changing that configuration could introduce failures of correctness or timeliness due to an exhaustion of available system resources.

To combat this, during the ahead-of-time characterisation process, the system can automatically vary the stimulus parameters of the audio processor in question and observe whether there is a change in the observed performance parameters. This can be used to find a ‘partial differentiation’ function for each performance variable with respect to each stimulus parameter.

Later, when the user is reconfiguring the processor, this information can be used to calculate the likely resource requirement implied by any proposed change, and thereafter indicate to the user if a proposed reconfiguration might result in the system exceeding its available resource budget, likely leading to failures.

### 4.2 Audio Processor Reliability Fuzzing (See 412-413 of FIG. 4)

Latent faults may be present in the implementation of audio processors which are not easily discoverable, only being triggered by unusual or uncommon combinations of input parameters. Such ‘trigger’ combinations are typically unknown until they occur during user experimentation.

To forecast failures of this nature, the system may perform ‘fuzzing’ on the processor's stimulus and audio inputs.

The technique of fuzzing involves repeatedly setting interface inputs to random values, waiting for the system under test (in the case of the system an audio processor) to exhibit a fault (in the case of the system, using fault detection techniques such as those discussed earlier), and then recording the stimuli that uncover faults.

To improve the fault detection rate of this process, the system may use guided fuzzing, where rather than using uniformly random stimuli, the system uses a stochastic normal distribution of parameter values that are centred around configuration values that have previously exhibited faults.

When provided with a new audio processor of unknown provenance, the system may perform a period of guided fuzzing of that processor to try and determine if there are any areas of its configuration space that are particularly likely to exhibit faults. The user can then be warned before configuring the audio processor into such a state that the audio processor may be unreliable in that configuration, or even prevented from configuring it into that state at all.

### 5 Fault Prevention

The system may prevent faults from manifesting at the system boundary through elements of its design. One example of such an element is modularising the system to prevent faults in one area of the system from creating faults in others. A second example of such an element is managing system resources to minimise the likelihood of failures due to resource starvation.

### 5.1 Subgraph Isolation

The system models an audio processing system as a directed acyclic graph, with any cycles having been removed by the system through the insertion of paired buffer nodes (“delta node inferral”). By partitioning such a graph into one or more disjoint subgraphs (subgraphs between which there are no edges), the system identifies separate units of processing that do not rely on each other. Such subgraphs may be referred to as ‘total subgraphs’.

By utilising isolation capabilities of the execution environment in which the audio system is running, the system may reduce a likelihood that a fault in one subgraph's processing affects the correctness or timeliness of another subgraph's processing. For example, in a conventional operating system, by running each subgraph's processing in a separate process, subgraphs cannot access each other's memory spaces, preventing memory corruption faults between subgraphs. In a real-time operating system, subgraphs could be run as separate tasks.

However, in practice some audio graphs may not be separable into multiple total subgraphs, due to many system outputs sharing data originating from the same system inputs. For example, a system might both have some ‘per-channel’ processing, and a global reverb processor into which every channel is also routed. In such a system there is only one total subgraph, which contains every node.

To overcome such an issue, the system may group output signal nodes which belong to the same logical channel into an ‘output terminal set’. The system may then perform a reachability analysis on the terminal set, finding nodes connected by edges of any direction to the nodes in the set, except that the system does not traverse any outbound edges from system input source nodes. The set of nodes so reached forms a subgraph which describes the set of audio processors used to compute the output data for that output terminal set, and other outputs that are derived from intermediate data created in the subgraph. Such set of nodes and their interconnections may be referred to as a ‘partial subgraph.’

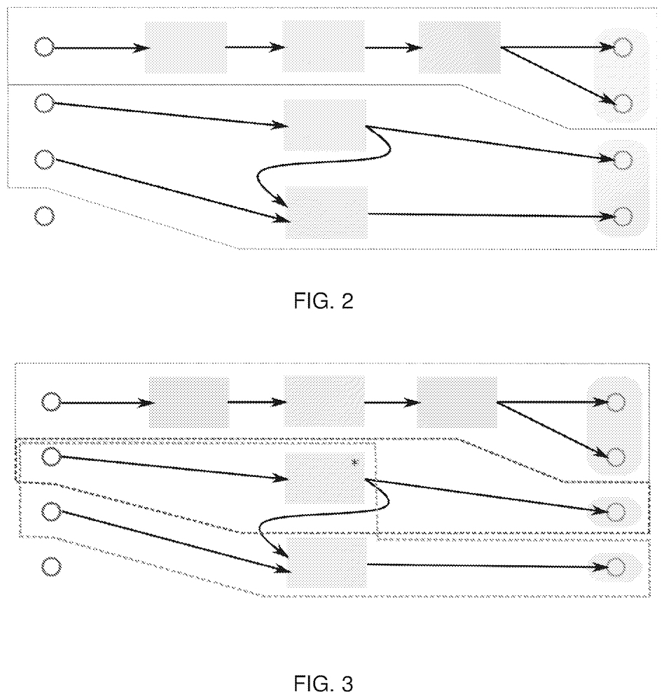

FIG. 2 illustrates partial subgraphs. FIG. 2 shows an audio processing graph having red input nodes and green output nodes. Audio processors are shown as yellow boxes. Output terminal sets are indicated as grouped output nodes, and the partial subgraphs are indicated by black dotted lines.

By isolating partial subgraphs (potentially routing some system inputs to multiple such partial subgraphs), the system may achieve a meaningful level of isolation between the processing responsible for each separate channel, meaning that a failure encountered in producing one output channel's data is isolated from creating a fault affecting another unrelated channel.

However, processors which share intermediate (non-system-input) audio streams as a ‘modulation’ or ‘control’ input (which may be termed a ‘side-chain’) may reside in the same partial subgraph, where a side-chained processor may be affected by a fault in the side-chain input's processing, even if that fault occurs later in the side-chain's signal path than the point at which the side-chain is used. To resolve such a situation, the system may use a reachability analysis that only ever follows inbound edges to a node, starting from the output terminal set. Such a reachability analysis may result in a set of subgraphs that may be referred to as ‘isolated partial subgraphs.’

FIG. 3 illustrates isolated partial subgraphs. The same audio processing graph as in FIG. 2 is shown partitioned into isolated partial subgraphs. The isolated partial subgraphs provide increased isolation between outputs. The output nodes have been partitioned into three output terminal sets, with data for the third and fourth output nodes (counting from the top) being generated by separate isolated partial subgraphs, indicated in orange and purple.

Each audio processor node in the original audio graph can potentially feature in more than one such isolated partial subgraph, when its output is required to produce outputs for more than one disjoint output terminal set. If the system computes the closure of nodes over the isolated partial subgraphs taking each set membership to be a distinct node, it may obtain more than one isolated partial subgraph node for each node present in the original audio graph.

By constructing each isolated partial subgraph as a separate set of processors, the system may process the same audio multiple times; but in so doing, it obtains improved isolation of each output terminal set. Such multiple processing is illustrated by the audio processor marked with an asterisk in FIG. 3, which features in two isolated partial subgraphs, and would therefore be processed twice.

### 5.2 Graph Transformation

In order to implement the user's requested processing, the system converts the specified graph into a form that can be executed linearly by a CPU 830. In order to achieve this, the system performs steps of the process illustrated in FIG. 4. In some embodiments, the Performance Measurement step 412 of FIG. 4 may be performed prior to other steps of the process illustrated in FIG. 4, to generate the Audio processor analysis data 413 used in the Inter-Subgraph Scheduling step 421 and the Intra-Subgraph Scheduling step 422. FIG. 4 illustrates the steps executed by a method according to the disclosure to transform a user's specified processing graph into audio processing schedules that can be executed by a CPU 830.

First, a user specifies 401 an audio processing graph or selects a pre-specified audio processing graph, incorporating audio processors from an available set of audio processor software modules 411. The available set of audio processors 411 may be provided by the user or may be listed in a configuration file of the system. Next, the system infers 402 any required delta nodes in order to convert the user-specified processing graph into an acyclic graph 403, as discussed in Sections 2.2 and 5.4.0.2.

Subsequently, the system performs the graph partitioning 404 discussed previously in Section 5.1 to obtain a set of isolated partial subgraphs 405. The system may expand 406 the set of isolated partial subgraphs with additional redundant subgraphs 407, as discussed in Section 6. The system then takes the resulting set of subgraphs, along with audio processor performance analysis data collected as discussed in Section 4, and performs inter-subgraph scheduling 421 (see Section 5.3) to generate a per-CPU schedule 431 and intra-subgraph scheduling 422 (see Section 5.4) to generate a per-subgraph schedule 432.

### 5.3 Inter-Subgraph Scheduling (See 421 in FIG. 4)

Once the system has divided the processing work to be done into partial or isolated partial subgraphs, what results are disjoint units of processing which have no shared data dependencies other than the input data. This means that the subgraphs can be processed concurrently and independently without needing to share intermediate data or perform synchronisation other than at the start and/or end of processing.

For improved performance, on commonly-found hardware it is preferable for the system to execute each subgraph totally for a given input buffer, rather than attempting to task-switch between subgraphs fairly. This reduces a context switch penalty in the hardware isolation mechanisms, as well as helping to keep the audio data for a buffer in the last-level-cache ready for low-latency access.

This is in contrast with the approach that many operating system pre-emptive schedulers take by default, which attempt to share CPU time fairly amongst eligible candidate tasks. Relinquishing the fairness guarantee provided by pre-emptive scheduling is acceptable in the system as it is desired that audio processors be bounded in their CPU time consumption, and further will yield their resources after having processed an output buffer of data, preventing other tasks from being starved of resources.

### Schedule Building

On many CPU architectures, there are multiple cores of execution which can be used to perform computation in parallel. The system may also compute the expected processing duration of an audio processor via the techniques discussed in Section 4.1.0.1.

Consequently, if the system is modelled in a two dimensional space spanning axes cores and time, the system may be considered as a rectangle of dimension N×T where N is the number of CPU cores in the system and T is the CPU time available for processing each block of audio (the block time). The system reserves a fixed proportion of T on each core for the system book-keeping overhead intrinsic in handing audio to the system, and to account for the fact that scheduling decisions will themselves change the observable performance of the audio processors due to microarchitectural interactions within the CPU that are difficult to model or measure. This reservation will effectively reduce the time dimension of the system rectangle.

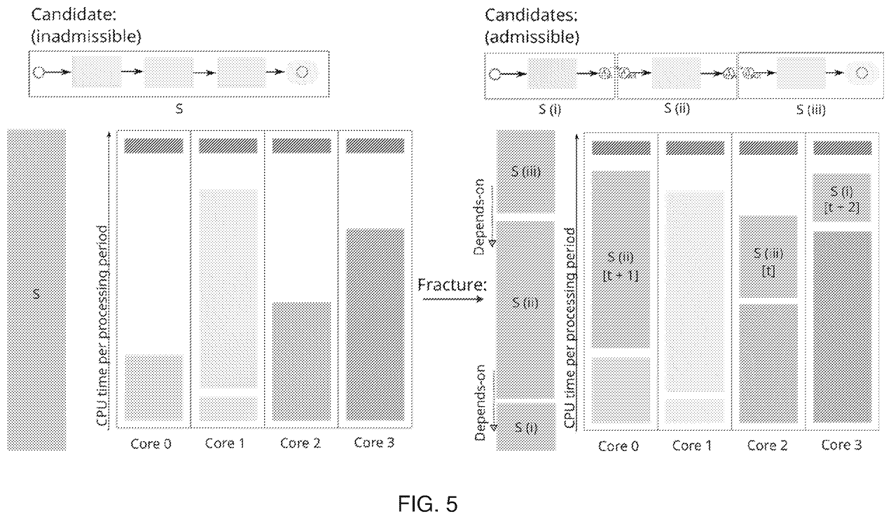

The system may then consider each subgraph to be a rectangle in this space with dimension 1×Σd+c where Σd is the expected sum of the deadline processing times for each processor in the subgraph and c is an approximation of the context switch overhead imposed when the CPU switches between subgraphs. The system may then allocate subgraphs to cores by finding a placement of all subgraph rectangles into the space via a simple generic programming or backtracking algorithm which seeks to fill each core by maximising the occupied area in the T dimension. This model is illustrated in FIG. 5. FIG. 5 illustrates the cores of a CPU represented as columns, with assigned subgraphs. The subgraphs are shown as differently shaded blocks. The overhead reservation on each core is shown as a grey block. FIG. 5 illustrates, on the left, an initial candidate schedule, with the cores of a CPU represented as columns, with assigned subgraphs shown as blocks that are shown having different sizes and shades. The overhead reservation on each core is shown as a fixed size block at the top of the column. FIG. 5 further shows that a proposed additional subgraph is not admissible into the initial candidate schedule despite there being enough ‘area’ (being the product of CPU cores and time) to admit the task. FIG. 5 further demonstrates how by fracturing the inadmissible subgraph into three, smaller subgraphs, a schedule can be built which admits the additional subgraph.

### Schedule Optimisation

To reduce the likelihood of a deadline overrun causing a fault, the system may not assign to each core as much processing as possible, maximising utilisation in T, but instead distribute the processing load across the available cores, maximising utilisation in N. The system swaps the axis of the score function used by the disclosed allocation algorithm to achieve this.

In performing this allocation, the system may weight subgraphs differently; if, from analysis, it is known that there are some subgraphs with a higher expected variance in their deadline times, the system may schedule them after other, more ‘deterministic’ subgraphs so that a deadline overrun is likely to impact fewer output terminal sets.

For performance, the system may also schedule subgraphs which share input nodes onto the same core, as this may help take advantage of cache locality of the input data. Similarly, the system may cluster subgraphs which share many of the same types of audio processor, as the execution environment may be able to alias audio processor memory resources between the two subgraphs, and scheduling the subgraphs closely-together would then exploit cache locality of those audio processors' data and code.

To achieve this, once the system has obtained an approximate solution, it may then use the result as a starting state for a genetic optimisation algorithm that operates by creating new mutated generations through swapping subgraphs at random to optimise a score function disclosed below. The system could either run this genetic algorithm for fixed number of generations, run it repeatedly until a given score is obtained, or run it until the score function appears to have reached a steady-state value (within a noise tolerance)

If the total score function is defined as S=Σsᵢ where sᵢ is the score function for the bin representing core i, then the system may model sᵢ as follows:

$${s}_{i} = {\sum }_{{p}_{i} = 0}^{{N}_{i} - 2} {Q}_{{p}_{i} , {p}_{i} + 1} + {W}_{i} - {P}_{i}$$

Here, Q_{xy} is a score function that evaluates the quality of pairing of two subsequent subgraphs, out of the N scheduled on core i. Wᵢ is a score which evaluates the quality of the ordering of subgraphs on core i. Pᵢ is a penalty function which applies pressure as the utilisation of core i increases, tending to a catastrophic penalty as the core becomes over-utilised.

The system may additionally or alternatively use a more advanced model for computing the total score S, for example factoring in the variance in score between cores and penalising solutions with high variance:

$$S = \sum {s}_{i} - \hat{s}$$

where ŝ is the expected variance for s given all sᵢ.

The system may calculate the score functions Q_{xy}, Wᵢ and Pᵢ as follows:

$${Q}_{xy} = {{m}_{Q} ( {{m}_{I} ( \frac{{I}_{xy}}{min ( {N}_{{i}_{x}} , {N}_{{i}_{y}} )} )}^{{n}_{I}} + {{m}_{C} ( \frac{{C}_{xy}}{min ( {N}_{{p}_{x}} , {N}_{{p}_{y}} )} )}^{{n}_{C}} )}^{{n}_{Q}}$$

Where I_{xy} and C_{xy} evaluate the number of shared inputs and the number of audio processors in common between subgraphs x and y respectively. Nᵢ_{ₓ} and Nₚ_{ₓ} are the number of inputs and audio processors in subgraph x, respectively.

$${c}_{i} = {min}_{p = 0 ... {N}_{i} - 1} {V}_{p}$$

$${b}_{i} = {max}_{p = 0 ... {N}_{i} - 1} {V}_{p}$$

$${a}_{i} = \frac{{b}_{w}}{{c}_{w}}$$

$${W}_{i} = - {{m}_{W} ( {\sum }_{p = 0}^{{N}_{i} - 1} \vert ( \frac{{a}_{i} p}{{N}_{i} - 1} + {c}_{i} ) - {V}_{p} \vert )}^{{n}_{W}}$$

Where Vₚ is a variance score indicating the jitter in processing times of audio processors in subgraph p. Wᵢ therefore increases in value as the ordering of the subgraphs become closer to following a linear increase in variance from lowest to highest. Wᵢ could be trivially expanded to include a user-defined or -derived priority figure in the Vₚ for a given processor, permitting ‘higher-priority’ subgraphs to be prioritised over lower-priority ones.

$${P}_{i} = - {m}_{P} {\vert ln ( 1 - \frac{{t}_{system}}{{t}_{buffer}} + \frac{{\sum }_{p = 0}^{{N}_{{p}_{i}} - 1} ( {t}_{switch} {t}_{p} )}{{t}_{buffer}} ) \vert}^{{n}_{P}}$$

Pᵢ decreases in value as the available spare processing time (t_{buffer} minus time consumed by the system t_{system}, context switching between subgraphs t_{switch}, and the processing of each subgraph itself tₚ) tends to zero. To tune this function, different base logarithms other than e could be selected.

m_{f} and n_{f} are, in all cases, tuning parameters which can be modified to alter the weighting of a scoring component f. The system implementer can use these parameters to adjust the relative importance of the different components in the scoring function according to the architectural details of the execution environment in which the processors are running, mirroring the relative importance of the architectural bottlenecks measured by each scoring component. m_{f} allows performance effects that scale linearly to be modelled, whereas n_{f} allows effects that scale super- or sub-linearly to be modelled.

### Scheduling

After Schedule optimization, each core has an ordered list of subgraphs to process. The system then causes the actual execution of the subgraphs to occur according to that schedule. The system causes the execution environment to schedule each subgraph only on the core it is intended to run on. The method for achieving this will depend on the execution environment, but on a conventional multi-core operating system this can be achieved setting the processor affinity or core scheduling cookie for each subgraph's process.

The system additionally takes action to cause the execution environment's scheduling system to schedule the subgraphs on a core sequentially instead of concurrently via time-sharing, running each subgraph's processing after the previous subgraph on that core. The exact method for doing this will also depend on the execution environment. On a conventional operating system, one approach is to prevent the subgraph's process from becoming runnable by having it block on a system-managed resource such as a semaphore or file descriptor, which the audio system causes to be satisfied after the previous subgraph has completed.

### Pipelining Subgraphs Across Periods

The preceding discussion of scheduling assumes that no subgraph has a T dimension which is larger than that of a given core of the CPU; that is to say, that no subgraph requires an amount of processing that takes longer than the available period time. It similarly does not address the situation where the sum of all subgraph time dimensions is less than the sum of all CPU core time dimensions, but nonetheless no schedule can be built which accommodates the processing that is to be performed. An illustration of this is given in FIG. 5, wherein a subgraph is inadmissible to the schedule on the left-hand-side of the figure until it is fractured, at which point it is admissible, as shown in the schedule on the right-hand side of FIG. 5.

For example, consider a case where there are 2 CPU cores with available time dimension T, and 3 subgraphs with time dimension 2T/3; there is no admissible schedule for those subgraphs despite there being enough total processing time available in sum.

In such cases, we can choose to perform pipelining via delta nodes, as discussed above in the section titled “Pipelining via delta nodes”, trading-off processing latency for throughput. To do so, we consider each delta node pair in the subgraph S, and recursively cut the subgraph into two fragments; the fragment on which the delta input node depends, and the fragment dependent on the delta output node. Each fragment is then itself a subgraph of S, with an acyclic dependency graph between each fragment. Doing so splits the T dimension of S in two, and in so doing makes it more likely that an admissible schedule can be found.

### 5.4 Intra-Subgraph Scheduling (See 422 in FIG. 4)

Within each subgraph the system then selects an order in which to run each audio processor. As an incomplete subgraph is not a useful output, there may be no reliability benefit to prioritising certain audio processors within a subgraph beyond optimising for performance. As such, the system attempts to maximise cache efficiency in this scheduling operation.

To schedule the subgraph, the system performs a breadth-first graph-walk from each system input source node. This produces a list of processors which are run for each ‘depth’ of traversed edges from the input nodes. At each depth, the list of candidate nodes is sorted according to their input edge nodes, and the sorted list then gets appended to the schedule. A benefit of this approach is that well-formed audio processors that use the same inputs are scheduled to run after each other, which should improve cache efficiency as the same data may be operated upon by multiple audio processors.

### Buffer Allocation

For each scheduled node, the system provides a buffer for its audio output data. Different buffer allocation processes may affect performance, so embodiments of the system may use one or more of the processes presented below. The system may allocate buffers during schedule planning and then the buffer allocations may remain constant during execution, helping to reduce microarchitectural sources of latency/jitter.

Buffer allocations can be modelled as an annotation on each node in the audio subgraph; the allocation process starts with buffers allocated and annotated on every system input source node and output sink node, as provided by the system audio infrastructure. Buffer identifiers may be ordered with respect to their layout in memory; that is, subsequently allocated buffers result in subsequently-located buffers, to help amortize cache paging costs across subsequent accesses by different audio processors.

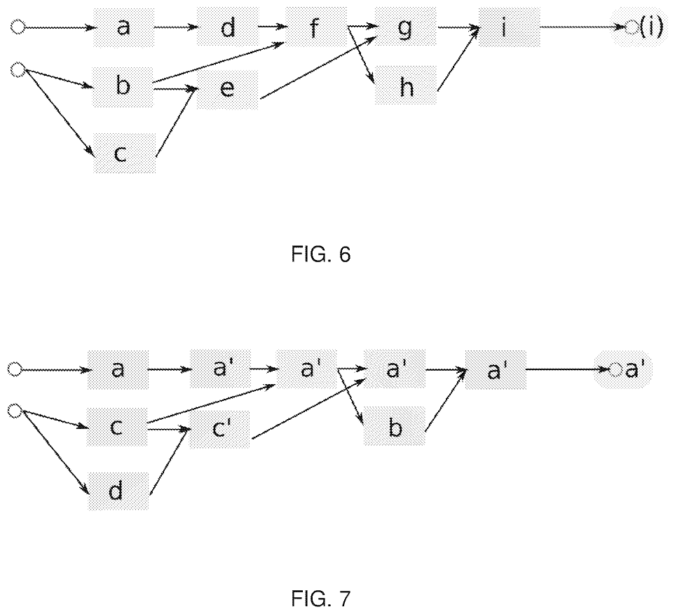

A first buffer allocation process is to perform a breadth-first walk of the audio subgraph, allocating a new buffer to every unannotated audio subgraph node, as illustrated in FIG. 6. FIG. 6 illustrates an assignment of buffers to audio processors in a subgraph indicating a result of the first buffer allocation process. Each processor's output buffer is indicated with a letter. It may be seen that this allocation strategy requires nine buffers for the nine processors in the audio graph. Such a strategy may result in the system using more buffers than it needs to, which may increase cache pressure and therefore reduce performance.

A second buffer allocation process performs a reverse-breadth first search on the audio subgraph once scheduling has been completed, starting with an output terminal set node, which will already be annotated. Such a process utilizes the concept of an annotated buffer (or audio subgraph node) being marked as ‘forwarded’. Buffers are not marked by default.

The second buffer allocation process considers each encountered node of the audio subgraph in turn. If the node is already annotated, it is ignored. Otherwise, the outbound audio processor node which is calculated last in the schedule is inspected to see if it is annotated and not yet forwarded. If it is, that node's annotation is copied to the current node, and that node's annotation is marked as being forwarded. Otherwise, a new buffer is allocated and assigned to the current node.

The second buffer allocation process results in sequential chains of audio processors reusing buffers wherever possible; the result of this algorithm when applied to the same audio subgraph that produced the buffer subgraph illustrated in FIG. 6 is shown in FIG. 7. FIG. 7 illustrates an assignment of buffers to audio processors in a subgraph showing simple reverse-breadth first search allocation with buffer forwarding. Annotated buffers are shown with letters, and a marking as ‘forwarded’ is shown with an apostrophe. When compared with FIG. 6, it may be seen how the same audio graph can be allocated with four buffers instead of nine.

### Sigma, Phi, and Delta Nodes

Sigma, phi, and delta nodes are special types of node that are provided directly by the system. A sigma node sums multiple signals. In some embodiments, the first inbound edge to this node writes its result directly into the sigma node's target buffer, with the sigma node summing additional inputs directly onto the target buffer.

A phi node provides a smooth transition between two versions of a subgraph. In some embodiments, in the steady-state when no transition is underway, the ‘active’ input to a phi node can write its output directly into the output buffer of the phi node. During a transition, the two inputs write their outputs into ‘mix’ buffers, which the phi node then blends between (using a linear interpolation or other blending algorithm) to produce its output buffer. Each phi node has two buffers allocated for this purpose, which are otherwise unused.

To reduce the runtime allocation of phi node buffers, some embodiments allocate a phi node buffer pool at startup of each subgraph, which can be used to insert phi-nodes on demand at any point in a graph without needing to allocate new buffers or alter the buffer allocation of the rest of the graph.

Delta nodes cut cycles in the processing graph by providing a feedback delay buffer as described in Section 2.2. It follows immediately from their function that they operate with a specially assigned buffer; the delta input node may forward its allocation but the delta output node may not be forwarded into (as it is, by definition, the same buffer as the delta input node from the previous graph execution).

For each size of buffer present in the system (normally, but not necessarily, the single buffer size used by all audio processors), the system maintains a single buffer pool which can be drawn from to provide buffers for ‘optionally’ inserted nodes (including phi nodes and delta nodes). As both nodes can use the same underlying buffer type, maintaining a single pool rather than split pools by type of buffer allows the system to reduce the total number of buffers required, reducing memory requirements in the system.

### Bypass Handling

A user, while operating the system, may choose to ‘bypass’ a specific audio processor. In this case, the processor's input is written directly to its output. This only makes sense where it is possible to unambiguously determine the input and output nodes which map to each other.

During bypass, in the case where there the previous node has only one output edge, then that previous node's output buffer can be replaced safely with the bypassed node's output buffer whilst it is bypassed. The bypassed processor remains in the schedule and is executed with a discard output buffer whose contents are ignored by the system whilst the processor is bypassed. Where multiple processors in a subgraph are bypassed, all the bypassed processors can write into a single discard output buffer.

### Scheduling

Similarly to when attempting to control the scheduling at the inter-subgraph level, within a subgraph the system attempts to ensure that the actual execution order of the audio processors reflects the desired schedule. As the audio processors within the subgraph do not run concurrently, a first method of doing this is to restrict the subgraph to a single thread of execution which sequentially executes the code associated with each processor.

A second method might make use of a system-provided thread scheduler present in the execution environment, which might allow for more fine-grained error handling and resource utilisation tracking at the price of thread context switches (which are cheap, unlike process context switches, but still not free). This second method, if used, could use similar signalling techniques to the inter-subgraph scheduling for each audio processor's thread to yield execution after it had computed its outputs and to block until activated by the scheduler.

### 5.5 Runtime Performance Measurement

Section 4.1 disclosed how ahead-of-time analyses can be used to characterise the resource requirements of a given processor. However, the system may also verify that the run-time performance of the processors in question is reasonably close to the predicted performance. Such verification is provided as, otherwise, the assumptions on which the disclosed scheduling decisions have been made will not hold, resulting in deadline failures and, possibly, observable failures. To this end, the system profiles both memory and time consumption of a subgraph, ideally

in as much detail as possible without introducing undue runtime overhead. Such profiles can then be compared with the modelled values obtained from the ahead-of-time predictions, and deviations can be used either as updated baseline predictions, or as failure indicators.

### CPU Time Performance Measurement

In various embodiments, CPU time is recorded using high-resolution timestamps at the beginning and end of the operation to be instrumented, and using their difference as an analogue of the amount of CPU time consumed by the process, under the assumption that the operation has not been pre-empted due to the one-active-task-per-core design of our system.

Timespans thus calculated may be normalised to the expected timespan for the set of operations in question calculated during scheduling, and then binned according to percent-of-nominal values, with bin counts thus producing a histogram of performance that can be updated with bounded memory consumption.

A timestamp taken at the beginning and end of each run through the schedule for a subgraph may be sufficient for evaluating the performance of the subgraph as a whole. If the subgraph's performance as a whole remains within an acceptable percentage of its nominal scheduled time, then this may be sufficient data to be confident that the subgraph is performing satisfactorily with respect to CPU consumption.

If the measured time bounds are very different from the expected values however, it may be necessary to understand what element of the schedule is consuming excess time. However, instrumenting each node in the subgraph individually could impose a significant performance burden, worsening the problem that the system is trying to investigate.

Consequently, in some such embodiments, the points within the schedule at which the timestamps are taken are variable, with their positions being decided dynamically, rather than being fixed at the beginning and end of the schedule. Initially, the two points may be positioned at the beginning and end of the schedule. When a performance issue is detected in the graph as a whole, a search may be performed by moving the dynamically-positioned points into the schedule, reducing the span of instrumented processors down to the partition defined between each timestamp point.

The system initially does not know how many faulty processors it is searching for (it may be that the fault is systemic and is affecting all processors). To this end, the system is interested in excluding portions of the schedule which are shown to have an acceptably close performance histogram to nominal, and continuing to inspect those sections whose performance deviate from normal.

After each ‘step’ of the search, the partition's histogram is inspected, and if its performance is acceptably close to nominal, its section of the schedule is marked as such and it is excluded from further investigation. However, if its performance is still non-nominal, the partition is explicitly marked as indeterminate, and is partitioned further in subsequent rounds of the algorithm. In this manner, the partitions can be reduced to a set of single processors whose performance is observably non-nominal, without the need for a timestamping and histogram-binning step after every processor in the system.

### Memory Consumption Performance Measurement

RAM allocation of an entire subgraph may be measured from memory allocation statistics obtainable from the execution environment's memory management system. Measuring per-audio processor memory consumption at runtime in a granular fashion is more challenging however, as all processors within a subgraph will draw from the same system heap. However, the system may take advantage of the fact that well-formed audio processors should not allocate more RAM in their audio processing thread, meaning that all allocations either occur at initialisation-time of the subgraph, or in a secondary thread spawned by the processor.

In some embodiments, the system may track RAM consumption as processor initialisations are serialised on a single-core subgraph, and so memory allocation statistics may be collected between initialisation of each processor. In other embodiments, the system may track runtime allocation of RAM by processors.

### Run-Time Interpretation and Remediation

Once runtime information regarding the normalised CPU-time or RAM-consumption performance of a set of audio processors in a subgraph has been obtained, the subgraph may interpret it. The system is interested in those processors and subgraphs which are exceeding their scheduled resource requirements predicted by the ahead-of-time characterisation.

In various embodiments, there may be two modes in which this can occur: first, where all audio processors in a subgraph are generally performing slightly worse than modelled, and second where a given audio processor is significantly exceeding its nominal budgets.

In the first case (which may be referred to as “chronic underperformance”), the system may be observing the micro-architectural and architectural impact of running the entire system concurrently, as opposed to the isolated measurement environment in which the ahead-of-time analyses were performed. In such a case, it is possible to characterise the performance degradation as a linear de-rating, which may be roughly constant across all processors and subgraphs in the system. This de-rating factor can be calculated at run-time and propagated back to the calculated schedules and used for the calculation of future schedules. If a subgraph fails to schedule after applying the observed multiplier, this information can be surfaced to the user allowing them to adjust their processing demand.

In the second case (which may be referred to as “acute underperformance”), it is possible that the system is observing a fault that has become observable within an audio processor, and as such it may be appropriate to invoke the fault removal response disclosed in Section 3.3; replacing the subgraph in question and triggering failover provisions.

### Avalanche Detection

In both the chronic and acute underperformance cases, if the system observes subgraph deadline misses actually occurring, it may take immediate corrective action, as repeatedly scheduled processing which takes more time than the schedule interval may quickly build up into a processing avalanche that may result in catastrophic system failure.

To this end, the system may invoke failover responses (as described in more detail in Section 6.1 and its subsections) where a single subgraph fails to meet timing; where there is a low-CPU redundant subgraph available, the system may choose to fail-over to that subgraph rather than potentially fail to meet timing for other subgraphs on the same CPU core.

However, the system may also detect if it has been unable to mitigate the failure of a single subgraph to meet timing and an avalanche has been triggered. This may present as a large proportion of subgraphs suddenly failing to meet timing by a significant margin. In some embodiments, a cross-subgraph supervisor collects statistics from all subgraphs to watch for this condition.

If an avalanche is detected, the system may avoid continued catastrophic system failure by completely stopping all processing, allowing all processing queues to drain, and then resuming processing afresh. In many execution environments, the quickest way to achieve this will be to terminate all processing by killing all extant subgraphs, and re-instantiating them from scratch. This approach has the advantage that if the execution environment itself is blocking forward progress of a subgraph for some reason, re-initialising the subgraph entirely is likely to remove this fault.

5.6 in-Subgraph Concurrency

In some embodiments, each subgraph is constrained to a single core. This allows the system to exploit the cache hierarchy of processors that have a per-core last-level-cache, whilst not imposing a significant penalty on system throughput in the envisioned usage, where there are likely to be many subgraphs, each of which are relatively simple. In such an execution environment, providing concurrency to the subgraph may not improve performance, as few subgraphs may describe parallel processing chains, and as such the second processor assigned to the subgraph for the duration of its execution might see low utilisation.

However, in other embodiments the last-level-caches may be shared amongst more than one core (for example, a pairing of two cores to a single cache), and there may be some subgraphs which exhibit significant parallelism and therefore may benefit from the allocation of more than one core of execution.

In some such embodiments, at the intra-subgraph level, a similar approach as that used for buffer allocation (see Section 5.4) may be used for core scheduling; e.g., a breadth first walk of the processing graph assigning each audio processor encountered to the next available schedule slot on any core in the schedule.

One challenge introduced by this approach is activating additional threads when their data dependencies are satisfied in a timely fashion. The method of doing so may depend on an in-subgraph scheduling method being used; if a user-mode scheduler is present and can react with a suitably low deadline time, then it could be used to manage activations; otherwise, one thread for each core could be created and they could spinlock the core until dependencies are satisfied by other cores.

### 6.1 Subgraph Redundancy

If a fault is discovered in a subgraph, either the subgraph may be terminated by the execution environment, or the system may decide to terminate the subgraph (as described in Section 3). However, once this has occurred, the system attempts to replace the failed subgraph in a timely manner. This section discusses approaches to achieve this.

### 6.1.1 Cold-Swap Subgraph Redundancy

Some embodiments employ cold-swap redundancy: that is, action is only taken to recreate a subgraph once its termination has occurred. This does not need to be a complete clean sheet, however; all graph analysis and schedule construction information can be cached by the audio system and used to recreate the new subgraph with the same instructions as the old one.

Such an approach has the advantage of having little run-time overhead: that is, few resources are intrinsically consumed by the approach because action is not taken until after a failure occurs. A downside of this approach, however, is that there are potentially long start-up times whilst the replacement subgraph is initialised. Additionally, the replacement subgraph will not have processed any of the past audio, which may produce audible changes in the output, especially in plugins with long ‘tail’ or ‘attack’ times.

### 6.1.2 Warm-Swap Subgraph Redundancy

In other embodiments, for each subgraph, the system may load a ‘backup’ subgraph into memory and initialise it with the same control parameters as the ‘live’ subgraph. By not calling upon the subgraph to actually execute any processing, in such embodiments the subgraph can be prevented from having any run-time processing overhead once initialised.

Because the warm-swap subgraph is already loaded into RAM when a failure occurs, upon failover the system starts sending audio sample data to the new subgraph. Whilst there may be a small ramp-up in performance due to cache warming occurring, the potentially slow allocation and loading of a cold-swap does not occur at the time of failure, reducing recovery times significantly.

After the ‘backup’ graph is pressed into service, the system may then recreate a new, replacement ‘backup’ graph to replace it, which may be done in a forced very-low-priority process on a core unrelated to the ongoing processing. To this end, it is necessary for the subgraph's process to support being scheduled on more than one core, depending upon the current mode of operation.

Some potential downsides to this approach are the cache-warming performance ramp, the same lack of past data in the replacement subgraph affecting output as in a cold-swap, and the residual RAM consumption of the hot-swap subgraph. Additionally, if another failure occurs during the startup time of the replacement subgraph, it may be necessary to wait until the replacement graph finishes initialising before it is available, effectively falling back to a ‘cold-swap’ approach.

### 6.1.3 Hot-Swap Subgraph Redundancy

The warm- and cold-swap approaches both incur non-zero recovery times and possible incorrectness of service due to the audio processors being started from ‘fresh’, but may provide the benefit of not consuming run-time processing time.

Other embodiments may run two or more instances of each sub-graph in parallel, with the same input audio data and parameter data. Such a system designates one replica of the subgraph as the ‘main’ subgraph. If that subgraph fails, the ‘backup’ subgraph is selected for output, potentially even without dropping a single sample: if the per-buffer output processing observes that the ‘main’ subgraph's output data has not been updated or is missing, it can simply use data from the ‘backup’ subgraph instead without any administrative book-keeping required.

In such embodiments, the ‘backup’ subgraph may consume both residual RAM and processing time, which may be on the same core (or at least last-level-cache) as the main subgraph, to exploit cache locality of the input data. However, for subgraphs with low processing overhead, such an approach may be pragmatic.

### 6.1.4 Common-Mode Failure Anti-Alias

A latently-visible fault in an audio processor in one subgraph may exhibit a fault similarly on all replicas if run with the same input audio data and configuration. Various embodiments attempt to ameliorate such behaviour.

### Combined Hot- and Warm-Swap

In some embodiments, the system creates both a hot-swap replica subgraph and a warm-swap replica subgraph, potentially using the same ‘fork’ optimisation to reuse read-only RAM pages between all three replicas. In this way, a ‘non-common-mode’ fault introduced through some timing-related or other non-deterministic fault gets the benefit of the improved performance of hot-swap redundancy, and the system only falls back to a warm-swap redundancy in the event of a ‘common-mode’ fault.

### Delayed Parameterisation

In other embodiments, the ‘backup’ hot-swap audio subgraph is run with the same audio data as the main subgraph, but with default parameter values for its audio processors. When a failure is detected and the hot-swap processor is required to take over, it is reconfigured to use the real parameter values.

Such embodiments may produce audible artefacts as a result of the audio processors reacting to the parameters being changed, but is likely to be more immune to common-mode faults affecting both subgraphs. To ameliorate this, for subgraphs with particularly low processing requirements, two redundant hot-swap subgraphs may be run, one with the delayed parameterisation, and one with the correct parameterisation, using the correct parameterisation in preference if the main subgraph fails.

### Pass-Through Replacement Subgraph

In some embodiments, a total failure to pass audio is treated as worse than just ‘failing-safe’ by passing through the input straight through to the output. Given that this requires almost no processing, this is a failover mode that is very likely to be successful.

However, given that it is possible for the correctly processed output audio to be significantly different to the input audio, a ‘pass-through’ failure may be undesirable. As such, the availability of this failover approach may be gated on user request.

### 6.1.5 Strategy Selection (See 406-407 in FIG. 4)

The relative cost-benefit trade-offs given by each of the above-outlined approaches mean that the best approach, or combination of approaches, may depend on the intrinsic resource consumption requirements of each subgraph in relation to the available system resources, and the relative priority that the user attaches to each subgraph, noting that this may vary considerably between subgraphs.

For example, a voice-modifier directly in-line in a processing chain might be both expensive but critical, justifying multiple layers of hot-swap redundancy despite the cost. Meanwhile, a relatively cheap ‘suboctaver’ effect might be an obvious candidate for hot-swap redundancy, but may actually be considered so expendable that the user would rather save the resource consumption and stick to a cold-swap approach.

To this end, the system allows the user to indicate a priority score for each configured subgraph, increasing values of which will result in the system using more resource-intensive redundancy methods. The system quantifies (in a relative fashion) and feeds back to the user additional processing burdens implied by their selected level of redundancy, to allow the user to make an informed decision.

### Opportunistic Dynamic Strategy Selection

In some embodiments, to opportunistically improve dependability, the system considers the redundancy scheme implied by the user's priority score as a ‘minimum’, with the system upgrading the redundancy mode transparently in the background if spare system processing capacity permits it.

Such upgrading may be displayed to the user in the form of a ‘pressure’ measure, which indicates how much resource ‘pressure’ the system is under (i.e. how little spare capacity the system has to improve reliability in the background), in relation to the amount of resource used by the configured processing.

### Bayesian Dynamic Strategy Selection

In some embodiments, the system records information about the audio processors present in a subgraph and the subgraph failures it observes over time, and uses this information to infer ‘risk’ scores for each configured subgraph.

To do this, the system may perform a Bayesian analysis, because when a subgraph fails the system does not know which audio processor within a Bayesian subgraph has caused the failure. Each failure that is encountered counts as a new entry into the corpus of the Bayesian model comprising the processors within the failed subgraph.

Such embodiments may also categorise the entries according to the type of failure that has occurred: for example, if two hot-swap subgraphs fail, the system may categorise the failure as a common-mode failure. If a one hot-swap subgraph fails but another doesn't, the system may categorise the failure as a non-common-mode failure.

With information as to the likelihood that any given audio processor contributes to a failure in general, a common-mode failure, or a non-common-mode failure, the system may combine these probabilities for each invocation of a processor in a subgraph to establish a subgraph risk for the likelihood of each type of failure.

With this information, the system may perform a statistically-guided approach to selecting an appropriate redundancy strategy: for example, if the system has information that a given subgraph is highly susceptible to common-mode failures but not susceptible to non-common-mode-failures, then for an audio processing system that has been targeted for hot-swap redundancy, the system might use a combined hot-and-warm-swap model, or a delayed-parameterisation mode.

This failure corpus information can be included as part of the ahead-of-time analysis performed by manufacturers, as outlined in Section 4, to provide the system with guidance without the need for it to fail when in use.

### 6.1.6 Subgraph Pre-Spooling

With both the cold- and warm-swap redundancy methods, audible artifacts may be produced in the output due to the lack of past audio data when activating a backup subgraph.

Some embodiments may attempt to prevent this, for subgraphs with relatively light processing demands, by buffering the last few seconds of audio for each input to the subgraph in the audio system. When a backup subgraph is then to be called into service, an amount of the past few seconds of audio for each input, as captured by the buffer, may be played through the subgraph, at above-real-time speed, discarding the output. This may put the replacement subgraph in a close approximation of the state that the recently-failed subgraph was in, having read and processed audio from the short period before the subgraph failover occurred.

To determine an appropriate length of ‘pre-spool’ buffer, the system may determine a likely required pre-spool amount from an inspection of the behaviour or configuration of the subgraph or system as a whole, or may receive the buffer length from a user.

### 6.1.7 Multi-Host Subgraph Distribution

The prior sections disclose how the system can utilise redundant instances of audio processors to improve the system's resilience to a failure in one of those software components. However, if those software components are being executed on the same hardware, this provides no resilience to failures of that hardware, or of the execution environment running on the hardware within which the audio processors are running. As the isolated partial subgraphs are independent from each other, there is no requirement that they be co-located physically; only that they can be presented with the same input signals and that their output signals can still be consumed.

Therefore, to ameliorate the risk of system failure due to a hardware failure, the system supports distributing its operation across a cohort of multiple hardware hosts in order to obtain hardware redundancy.

In some embodiments, all hardware hosts are homogeneous, but this is not required. In other embodiments the hardware hosts are heterogeneous hosts. Some such embodiments identify a minimum common subset of functionality across all nodes in the cohort, and then treat all nodes in the cohort as if they were instances of that subset, producing a homogeneous cohort.

Some phases involved in achieving hardware redundancy are as follows:
Leadership election
State replication
Partition planning
Output subscription
Failure detection

In leadership election, the system chooses a single host in the cohort to be a leader. The leader exclusively accepts configuration data changes from the user. The leader is responsible for state replication, where the system state is synchronised between all hosts in the cohort. In partition planning, specific hosts in the cohort are then selected to execute specific subsets of the work to be done, taking into account redundancy goals of the system. In output subscription, the system reverses the fanning-out of redundant processing, so that the system's output signals are correctly consumed by downstream receivers irrespective of which host in the cohort generates them. Finally, in failure detection, the entire cohort monitors for operation (or malfunction) of at least some other hosts in the cohort, reacting by adjusting the partition planning accordingly, and in the case of a leader host failure, by additionally re-performing leadership election.

### Leadership Election

The system starts by identifying one host in the cohort as the leader. The set of hosts in the cohort can either be configured manually by the user, or participant hosts in the cohort can be discovered automatically on the network where all hosts in the system broadcast discovery messages.

In the latter scheme, all hosts broadcast their identity plus the set of hosts which they have discovered. Any host receiving such a message computes the set intersection between the hosts that they know about and the hosts that another host on the network knows about, to produce the commonly-known subset of hosts. This produces the cohort. Once the cohort has been established, one host from the cohort is selected to become the leader.

In some embodiments, such selection may be achieved by the user identifying a given host manually as the leader, by some reliability-proxy metric (e.g. highest uptime), or pseudo-randomly via some stable but otherwise meaningless sorting comparator (such as lowest serial number).

### State Replication

Once an initial leader has been identified, the leader relays the user's desired configuration (including the audio graph structure, schedules, and stimulus parameter data for all audio processors) continually to all hosts in the cohort. This process occurs in two phases; initial bulk transfer, followed by update transfer.

In initial bulk transfer, the entire system state of the leader host is transferred en masse to the follower hosts, with each follower host discarding its own state and replacing it with the received one.

Once the initial bulk state data transfer has occurred, the leader system then sends updates to the follower hosts to keep them up-to-date. In some embodiments, the system performs this by applying commands received from the user to the leader's internal state and then sending messages describing the resultant changes in the leader's state data (‘state deltas’) to at least some follower hosts. For a system with a significant number of data describing its state however, or with commands that result in modifications of many state data, this can result in poor performance due to a large amount of data transfer being created by a command.

Some embodiments may avoid such large data transfers by sending commands from the user concurrently to all hosts, which apply them all concurrently. Without more, this approach has the risk that all the hosts do not apply the commands at the same time instant, resulting in divergent states between hosts. To resolve this, commands can be timestamped upon creation a short distance into the future, and then only applied by the recipient host at the exact time indicated. Equivalently, commands could be timestamped correctly upon creation, and all hosts in the cohort are configured with a small offset which is applied to the creation time to determine the application time. Combined with accurate clock-sync across the network (which should be present where the system is synchronously processing audio), such timestamps should result in system states which are synchronised between all hosts in the cohort. Any host in the cohort therefore has the required data to perform processing of any subgraph.

The system uses commands that are designed to be deterministic for such ‘command’ replication; that is, the change in state effected by the application of a given command on one host with a given starting state is identical to its independent application on a different host having an identical starting state.

### Partition Planning

Once any given host has the ability to perform processing for any subgraph in the system, the leader may then allocate specific processing duties to each host in the cohort. This is very similar to the inter-subgraph scheduling problem described in Section 5.3, except that in partition planning the set of processing cores available is not just the cores on one host, but instead the cores available across all hosts in the cohort.

The system takes advantage of the hardware redundancy offered by this scheme by taking into account which subgraphs are redundant replicas of each other, and excluding a host which is already running one replica of a subgraph from hosting a second replica. In some embodiments, this is achieved by excluding such a host's cores from a candidate core set when placing the replica subgraph initially. During a genetic evolution phase, such embodiments may also severely negatively penalise candidate solutions which co-host redundant subgraphs.

Once planning of a partition is complete, the system may save the placed schedule (e.g., the schedule of subgraphs assigned to cores and which hosts within the cohort those cores exist within), such that the outputs of each host in the cohort do not change on subsequent restarts of the system. This allows the user to configure their audio network with downstream subscriptions to hosts in the cohort as appropriate.

### Output Subscription: Intra-Network Approach

Once specific hosts have been selected for processing individual subgraphs, the system then subscribes downstream receivers to a correct host to receive desired outputs. Embodiments with a single available audio network may perform output subscription as follows.

When the schedule is initially built on a single host, the user will use the network audio protocol through which the system is interfacing to subscribe receiving devices to signals being transmitted by the system. Once the system has been distributed via partition planning, a number of those signals will now be generated by other hosts in the cohort. The leader, having performed partition planning, maintains a mapping for each signal to the new host generating it. After the new host is assigned a given subgraph and starts producing its output signals, the leader uses this mapping to instruct the network audio protocol to migrate the subscription from the original single host to the new, redundant host, causing the downstream receiver devices to continue to receive the desired signal without the user's intervention.

### Output Subscription: Inter-Network Approach

Some embodiments employ dual audio networks to provide a primary/failover network configuration. In such embodiments, the system leverages the redundant properties of the network by having redundant pairs of hosts present themselves inversely to the two audio networks; host X registers as host A on the primary network and as host B on the failover network, and another host Y registers as host B on the primary network and as host A on the failover network.

Thus, if host X fails and stops transmitting audio, receiver devices subscribed to host A will assume that the primary network has failed and will fail over to the secondary network, upon which host Y will be transmitting data as host A.

In such embodiments, the system modifies partition planning such that hosts in the cohort are pre-paired, and the set of candidate cores for a given redundant subgraph are only those provided by the paired host of the host running the primary subgraph.

FIG. 8 illustrates various redundancy schemes according to the disclosure which can be used to leverage extant support for network redundancy (that is, use of a redundant network to provide correct service even in the event of a fail-stop network fault in a single network) to provide support for host redundancy.

Sub-figure a) illustrates a conventional network redundancy setup, with two parallel independent networks M and N providing connectivity between a host X and a client C. Sub-figure b) illustrates use of the same two networks to provide host redundancy, wherein the same logical host X is implemented by two physical hosts A and B. This arrangement suffers from a limitation in redundancy however; in the event of failure of either M or N, host redundancy is lost. Sub-figure c) therefore extends this arrangement to provide both network and host redundancy; either of A or B can fail and maintain correct service, and this property is true even under failure of either of M or N. Sub-figure d) shows the equivalent of sub-figure a) in a configuration with multiple hosts X and Y performing distributed processing, with no host redundancy between X or Y but with network redundancy between M and N. Sub-figure e) then extends the principle from sub-figure c) to the distributed host case; in this scenario, pairs of physical hosts (A, B) implement pairs of logical hosts (X, Y) in a converse manner such that full host redundancy is available in addition to network redundancy. In sub-figures a) through d), the fault detection and failover tasks occurs automatically as a direct consequence of the baseline network redundancy implementation utilised by the technique. In sub-figure (e), in the event of a failure of a single network N, co-ordination is required between A and B to cause B's secondary interface to instead implement logical host Y, to restore correct service.

This method of providing host redundancy confers a significant advantage in implementation in that that there are many extant clients that already support network redundancy, and this method leverages that fact to provide a wider scope of redundancy (to additionally cover host failure) than that scheme was originally conceived to provide-existing state of the art in audio over IP networks requires all hosts to present identically on both the primary and the secondary networks.

### Failure Detection

Finally, in order to leverage the redundant processing that is now occurring, the system monitors for failures in order to react appropriately. The system may employ one or more of three general methods for monitoring for failures; internal failure detection, liveness failure detection, and network failure detection.

In internal failure detection, the host itself monitors the processed subgraphs for failure via the various failure detection methods discussed previously in Section 3, and, when a fault is detected, notifies the leader so that failover can be triggered whilst it performs fault removal.

In liveness failure detection, hosts in the cohort attempt to maintain regular contact with each other via ‘ping’-style messages, sent to each other at randomised intervals, or at intervals determined via some other intrinsic property of the host, such as its serial number. A first host maintains a count of the missing replies from a second host in a given time window; if the second host, for a certain amount of time, fails to reply or a certain number of response messages are observed to be missing, the first host notifies the leader. If the number of hosts in the network notifying the leader that the second host is unreachable exceeds a threshold within a predetermined time window, then the second host is considered to have failed, and the leader commences failover for all subgraphs located on that host.

In some embodiments, the threshold may be a simple majority of hosts in the cohort, but other embodiments may use other proportions. The proportion may vary based on the time over which missing replies are observed, which may be suitable depending on a projected lossiness of the network and/or a desired avoidance of unneeded host failover.

In network failure detection, the audio processing network itself is queried to determine which transmitters are currently maintaining an active subscription in the network. If a host which is expected to be transmitting drops its subscriptions, then a failure is considered to have occurred and the leader commences failover for all subgraphs located on that host.

### Fault Removal

When the leader commences failover to remove a fault from the system, it has two key tasks; partition replanning and output resubscription.

Partition replanning involves selecting one or more new hosts to take over from the duties of the failed host. This may only be necessary in a case where the entire host has failed; if the failover was triggered by internal failure detection on a specific subgraph, the host can continue to have responsibility for processing that subgraph. However, if the entire host has failed, the leader transfers its responsibilities to one or more new hosts. To do so, the leader may continue the inter-core subgraph scheduling algorithm, removing all subgraphs from the failed core(s) and placing them onto the cores which remain. In so doing, subgraphs which are not currently being processed by any host (either because they have no redundant subgraphs or because all hosts running the redundant subgraphs have failed) may be placed first, having priority over subgraphs which already have redundant copies running.

Once a new schedule has been determined, the leader communicates it to all hosts and builds a new host-signal map. The host then uses this new map to re-perform output subscription, mapping receiver audio network subscriptions to the new hosts providing the desired signals. In a case where inter-network output subscription was used initially and one of the two failover hosts is still providing correct service within the cohort, this step may be skipped where the redundant host will be providing service on the failover network.

### Leader Failure Detection and Replacement

If a host believes the leader to have failed, the host broadcasts a leadership failure message to the cohort whilst maintaining a record of those hosts from which it has received a leadership failure message. If a certain threshold of other hosts in the cohort believe the leader to have failed within a predetermined time window, then the leadership election process is triggered before fault removal is started. In some embodiments, the threshold may be a simple majority of hosts in the cohort, but other embodiments may use other proportions. The proportion and time window may vary based on a projected lossiness of the network and/or a desired avoidance of unneeded leadership elections.

### 7 Conclusion

Disclosed is a novel system for running audio processors in a dependable yet performant fashion on modern digital processing hardware.

A system design is outlined that is based on a constructed directed acyclic graph of audio processors. Methods of fault detection, including via direct audio analyses and metadata analyses, are provided.

Models for characterising the resource requirements and performance of processors as a method of forecasting failures are provided, as well as the applicability of ‘fuzzing’ techniques to discover latent faults that may otherwise lie undiscovered.

Furthermore, the design of a system according to the disclosure intrinsically admits an implementation on commercially available hardware that can be made resilient yet performant. Algorithmic implementation approaches are provided that illustrate how tight time bounds can be modelled whilst algorithmically maximising potential performance by making processing allocation decisions that are sympathetic to the workload and target hardware. Approaches for measuring the run-time performance of the system and comparing it to the ahead-of-time characterisations to aid fault detection are also provided.

A runtime-redundancy approach to fault tolerance and recovery is provided, as a route to dependability in the system, along with various strategies for implementation.

In sum, a system design for a modular audio processing system with high dependability is disclosed. The system combines a novel model for audio graph partitioning and redundancy with a number of algorithmic approaches to adapt variable processing loads to commercially available hardware and provide meaningful fault tolerance, leading to a system that can provide both high performance and high dependability.

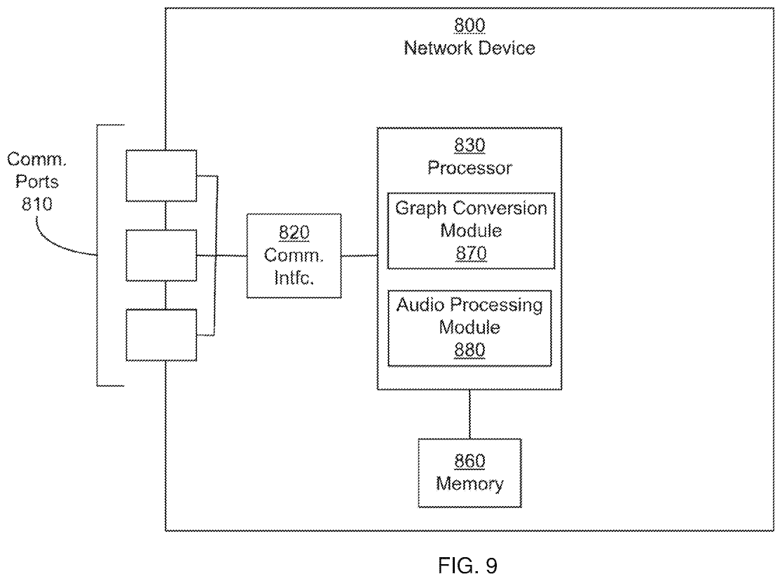

FIG. 9 is a block diagram of a network device 800 (e.g., the network device 102) according to the disclosure. The network device 800 is suitable for implementing the disclosed embodiments as described herein. The network device 800 comprises communication ports 810 for communicating information via a network (e.g., the network 104); a processor, logic unit, or central processing unit (CPU) 830 for processing the information; and a memory 860 for storing the information. The network device 800 may also comprise optical-to-electrical (OE) components and electrical-to-optical (EO) components coupled to the communication ports 810 communication of optical or electrical signals.

The processor 830 is implemented by hardware and software. The processor 830 may be implemented as one or more CPU chips, cores (e.g., as a multi-core processor), field-programmable gate arrays (FPGAs), application specific integrated circuits (ASICs), and digital signal processors (DSPs). The processor 830 is in communication with the communication ports 810 via the communication interface 820. The processor 830 is also in communication with the memory 860. The processor 830 comprises one or more of a graph conversion module 870 and/or an audio processing module 880. The graph conversion module 870 and the audio processing module 880 implement the disclosed embodiments described herein. For instance, the graph conversion module 870 processes an audio processing graph received from the user station 106 to generate a dependable real-time audio processing system, and the audio processing module 880 processes audio signals received from the audio sources 110 using the real-time audio processing system and sends the processed signals to the audio sinks 112. The inclusion of the graph conversion module 870 and the audio processing module 880 therefore provides a substantial improvement to the functionality of the network device 800 and effects a transformation of the network device 800 to a different state. In some embodiments, the graph conversion module 870 and the audio processing module 880 are implemented as instructions stored in the memory 860 and executed by the processor 830.

The memory 860 comprises one or more disks, tape drives, and solid-state drives and may be used as an over-flow data storage device, to store programs when such programs are selected for execution, and to store instructions and data that are read during program execution. The memory 860 may be volatile and/or non-volatile and may be read-only memory (ROM), random access memory (RAM), ternary content-addressable memory (TCAM), and/or static random-access memory (SRAM).

While only some embodiments of the disclosure have been described herein, those skilled in the art, having benefit of this disclosure, will appreciate that other embodiments may be devised which do not depart from the scope of the disclosure herein. While the disclosure has been described in detail, it should be understood that various changes, substitutions, and alterations can be made hereto without departing from the spirit and scope of the disclosure.

1-23. (canceled)

24. A method for generating a dependable real-time audio processing system, the method comprising:
inferring (401-403) delta nodes to convert a received cyclic audio processing graph into an acyclic audio processing graph, by breaking a cyclic chain of edges in the cyclic audio processing graph;
partitioning (404-405) an acyclic audio processing graph to generate one or more isolated partial subgraphs;
measuring performance (412) of one or more audio processors in the isolated partial subgraphs;
analyzing the measured performance (412) of the one or more audio processors to generate audio processor analysis data (413); and
performing at least one of:
inter-subgraph scheduling (421) using the isolated partial subgraphs and the audio processor analysis data (413) to generate a per-CPU schedule (431); and
intra-subgraph scheduling (422) using the isolated partial subgraphs and the audio processor analysis data (413) to generate a per-subgraph schedule (432).

25. The method according to claim 24, the method further comprising:
configuring an audio processing system according to the per-CPU schedule (431) and the per-subgraph schedule (432).

26. The method according to claim 24, the method further comprising:
adding (406-407) redundancy to one or more of the isolated partial subgraphs.

27. The method according to claim 26, wherein:
the per-CPU schedule (431) is generated by performing inter-subgraph scheduling (421) using the isolated partial subgraphs (407) and the audio processor analysis data (413).

28. The method according to claim 26, wherein:
the per-subgraph schedule (432) is generated by performing intra-subgraph scheduling (422) using the isolated partial subgraphs (407) and the audio processor analysis data (413).

29. The method according to claim 24, wherein:
the audio processing graph is received (401) by it being specified by a user.

30. The method according to claim 24, wherein:
the audio processing graph is received (401) by the user selecting a pre-specified audio processing graph.

31. The method according to claim 24, wherein:
the audio processing graph is received (401) from an available set of audio processor software modules.

32. The method according to claim 24, wherein:
measuring the performance (412) and analyzing the measured performance (413) are performed before the inferring (401-403) of the delta nodes and the partitioning (404-405) of the acyclic audio processing graph.

33. The method according to claim 24, the method further comprising:
inserting one or more nodes into the acyclic audio processing graph, wherein the one or more nodes includes a sigma node, a phi node and/or a delta node.

34. The method according to claim 24, the method further comprising:
performing parallel processing of the acyclic audio processing graph.

35. The method according to claim 24, the method further comprising:
performing (412-413) fault detection of the one or more audio processor by analysis of input data that is provided to the one or more audio processor and output data that is received from the one or more audio processor.

36. The method according to claim 24, the method further comprising:
performing (412-413) fault detection of the one or more audio processor by analyzing memory consumption of the one or more audio processor.

37. The method according to claim 24, the method further comprising:
performing (412-413) fault detection of the one or more audio processor by setting one or more input stimulus parameters, detecting whether the one or more audio processor exhibits a fault, and recording the one or more input stimulus parameters if the fault is detected.

38. The method according to claim 24, the method further comprising:
employing dual audio networks to provide a configuration comprising a primary network and a failover network.

39. The method according to claim 38, the method further comprising:
a first parallel and independent audio network (M);
a second parallel and independent audio network (N);
a logical host (X) configured to perform a set of processing tasks;
a first parallel and independent implementation of the logical host (A);
a second parallel and independent implementations of the logical host (B); and
a client (C) configured to exchange data with the logical host (X) via the first and second audio networks (M, N), the client (C) being configured in a primary/secondary redundant arrangement;
wherein:
the first logical host (A) presents itself as the logical host (X) on the first audio network (M); and
the second logical host (B) presents itself as the logical host (X) on the second audio network (N);
such that if the first logical host (A) were to fail, the client (C) would assume that the first audio network (M) has failed, and fall back to the second audio network (N), wherein correct service would be restored due to the function of the second logical host (B).

40. A program which, when executed by a computer, causes the computer to perform a method for generating a dependable real-time audio processing system, the method comprising:
inferring (401-403) delta nodes to convert a received cyclic audio processing graph into an acyclic audio processing graph, by breaking a cyclic chain of edges in the cyclic audio processing graph;
partitioning (404-405) the acyclic audio processing graph to generate one or more isolated partial subgraphs;
measuring performance (412) of one or more audio processors in the isolated partial subgraphs;
analyzing the measured performance (412) of the one or more audio processors to generate audio processor analysis data (413); and
performing at least one of:
inter-subgraph scheduling (421) using the isolated partial subgraphs and the audio processor analysis data (413) to generate a per-CPU schedule (431); and
intra-subgraph scheduling (422) using the isolated partial subgraphs and the audio processor analysis data (413) to generate a per-subgraph schedule (432).

41. An audio processing system configured to implement a method for generating a dependable real-time audio processing system, the method comprising:
inferring (401-403) delta nodes to convert a received cyclic audio processing graph into an acyclic audio processing graph, by breaking a cyclic chain of edges in the cyclic audio processing graph;
partitioning (404-405) the acyclic audio processing graph to generate one or more isolated partial subgraphs;
measuring performance (412) of one or more audio processors in the isolated partial subgraphs;
analyzing the measured performance (412) of the one or more audio processors to generate audio processor analysis data (413); and
performing at least one of:
inter-subgraph scheduling (421) using the isolated partial subgraphs and the audio processor analysis data (413) to generate a per-CPU schedule (431); and
intra-subgraph scheduling (422) using the isolated partial subgraphs and the audio processor analysis data (413) to generate a per-subgraph schedule (432).

42. The audio processing system according to claim 41, the system comprising a multi-core processor.
